(19) United States
(12) Patent Application Publication
(10) Pub. No.: US 2026/0142067 A1
(43) Pub. Date: May 21, 2026

(54) COIL COMPONENT, METHOD FOR MANUFACTURING COIL COMPONENT, AND ELECTRONIC/ELECTRIC DEVICE

(71) Applicant: DELTA ELECTRONICS (JAPAN), INC., Tokyo (JP)

(72) Inventors: Akihiro YOSHIDA, TOKYO (JP); Michio KAMIMURA, TOKYO (JP); Naoki SAKAZUME, TOKYO (JP); Ikuo KOYAMA, TOKYO (JP); Kenji HASHIZAKI, TOKYO (JP)

(73) Assignee: DELTA ELECTRONICS (JAPAN), INC., Tokyo (JP)

(21) Appl. No.: 19/408,391

(22) Filed: Dec. 4, 2025

Related U.S. Application Data
(63) Continuation of application No. PCT/JP2023/021228, filed on Jun. 7, 2023.

(51) Int. Cl. H01F 27/28; H01F 27/255; H01F 41/04

(52) U.S. Cl. CPC H01F 27/2804; H01F 27/255; H01F 41/041; H01F 2027/2809

(57) ABSTRACT

A coil component has a portion connecting external electrodes to a coil and exhibits excellent electrical properties. The coil component includes: a coil conductor portion having a first spiral conductor portion that has a spiral shape when viewed in a first direction (Z1-Z2 direction), and a first connecting conductor portion that has a first protrusion part protruding further than the first spiral conductor portion to at least one side in the first direction and contacts one of two end parts of the first spiral conductor portion; and a main body portion that covers the first spiral conductor portion with two intersecting surfaces arranged alongside in the first direction and contains magnetic powder. The first connecting conductor portion has a first exposed region exposed from the main body portion, and the first protrusion part has a portion formed by a continuous body extending in the first direction.

### CROSS REFERENCE TO RELATED APPLICATIONS

This application is a continuation application of PCT Application No. PCT/JP2023/021228, filed on Jun. 7, 2023. The content of the application is incorporated herein by reference.

### BACKGROUND OF THE INVENTION

### 1. Field of the Invention

The present invention relates to a coil component and a method for manufacturing the same. The present invention also relates to an electronic/electric device, in which the coil component is installed.

### 2. Description of the Related Art

Patent document 1 discloses a body; a coil portion disposed in the body and including a lead-out pattern; an external electrode disposed on a first surface of the body; and a plurality of connection vias disposed in the body, connecting the external electrode to the lead-out pattern, and integrated with each other, wherein, in each of the plurality of connection vias, a size of an end surface area of a lower portion adjacent to the external electrode is different from a size of an end surface area of an upper portion adjacent to the lead-out pattern.

### PRIOR ART DOCUMENT

### Patent Document

[Patent Document 1] US Patent Publication No. 2022/0189680

### SUMMARY OF THE INVENTION

### Problems to be Solved by the Invention

The multiple connection vias of the coil component disclosed in Patent Document 1, although integrated, have interfaces that cross the lines connecting the external electrodes and the lead-out patterns. This interface increases contact resistance, which may adversely affect the electrical characteristics of the coil component (particularly the direct current resistance value DCR).

The present invention aims to provide a coil component that has a portion that connects an external electrode and a coil as described in Patent Document 1 and has excellent electrical characteristics. The present invention also aims to provide a method for manufacturing the coil component, and an electronic/electric device in which the coil component is mounted.

### Means to Solve the Problems

In one aspect of the present invention provided to solve the above problems, a coil component includes a coil conductor portion and a main body portion. The coil conductor portion includes a first spiral conductor portion having a spiral shape when viewed in a first direction, and a first connecting conductor portion having a first protrusion part protruding further than the first spiral conductor portion on at least one side in the first direction and contacting one of a pair of end parts of the first spiral conductor portion. The main body portion covers at least the first spiral conductor portion with a pair of intersecting surfaces arranged alongside in the first direction, and includes magnetic powder. The first connecting conductor portion has a first exposed region exposed from the main body portion, and the first protrusion part has a portion formed by a continuous body extending in the first direction.

In this specification, the “portion formed by a continuous body” refers to a series of parts that are manufactured by a single shape forming process (a specific example is a plating process) and do not have any particular bonding interface. Since the first protrusion part is a continuous body, there is no interface that would increase the resistance when a current flows in the first direction. For this reason, the provision of the first protrusion part makes an increase in resistance unlikely to occur, resulting in a coil component with excellent electrical properties.

In the coil component described above, the first exposed region may have a first exposed part exposed from the intersecting surfaces.

In the coil component described above, the main body portion may have an outer surface extending in the first direction between the pair of intersecting surfaces. In this case, the first exposed region may be exposed from a portion of the main body portion other than the outer surface.

In the coil component described above, the outer surface may be covered with a surface insulator portion.

The coil component described above may have a first external electrode provided outside the main body portion and in contact with the first exposed part.

In the coil component described above, the main body portion may have an outer surface extending in the first direction between the pair of intersecting surfaces. In this case, the first exposed region may have a second exposed part exposed from the outer surface. The second exposed part may be formed from a cut surface.

In the coil component described above, the main body portion may have an outer surface extending in the first direction between the pair of intersecting surfaces. In this case, the first exposed region may have a first exposed part exposed from the intersecting surfaces, and a second exposed part connected to the first exposed part and exposed from the outer surface.

The coil component described above may have a second external electrode provided outside the main body portion and in contact with the second exposed part. In this case, the first exposed region may have a first exposed part exposed from the intersecting surfaces, and the second external electrode may extend so as to also contact the first exposed part.

In the coil component described above, the first protrusion part may protrude further than the first spiral conductor portion on both sides in the first direction.

In the coil component described above, the first protrusion part may protrude further than the first spiral conductor portion on one side in the first direction.

In the coil component described above, the first connecting conductor portion may extend from an outer end of the pair of end parts of the first spiral conductor in a direction intersecting the first direction, and may include a first base portion facing the first protrusion part at one end in the first direction, and a first end via conductor portion electrically connecting the first protrusion part and the first base portion.

In this case, in the first protrusion part, a position in the first direction where the cross-sectional area perpendicular to the first direction is minimal may be closer to the first end via conductor portion than a position in the first direction where the cross-sectional area perpendicular to the first direction is maximal. The first exposed region may have a first exposed part exposed from the intersecting surfaces, and a cross section of the first protrusion part perpendicular to the first direction may have a maximal area at the first exposed part.

In the coil component described above, the coil conductor portion may have a portion formed by a laminated structure, which includes a first conductor portion and a second conductor portion provided on a surface of the first conductor portion. In this case, the second conductor portion located in the first spiral conductor portion and the second conductor portion located in the first connecting conductor portion may be a continuous body. The first exposed region may have a first exposed part exposed from the intersecting surfaces, and the second conductor portion may also be located in the first exposed part. The surface of the first conductor portion may have a first surface facing the first direction and a second surface extending in the first direction, and the second conductor portion may be provided on both the first surface and the second surface.

In the coil component described above, the coil conductor portion includes a second spiral conductor portion arranged alongside in the first direction with the first spiral conductor portion and having a spiral shape when viewed in the first direction. The coil conductor portion further includes a second connecting conductor portion including a second protrusion part, which protrudes further to at least one side in the first direction than the second spiral conductor portion, and contacting one of a pair of end parts of the second spiral conductor portion. The coil conductor portion further includes a via conductor portion in contact with one end of the first spiral conductor portion and one end of the second spiral conductor portion to electrically connect the first spiral conductor portion and the second spiral conductor portion in the first direction. The second connecting conductor portion may have a second exposed region exposed from the main body portion, and the second protrusion part may have a portion formed by a continuous body extending in the first direction.

In this case, the first spiral conductor portion, the second spiral conductor portion, and the via conductor portion may have a portion formed by a continuous body. The first exposed region may include a first exposed part exposed from the intersecting surfaces, and the second exposed region may have a third exposed part exposed from the intersecting surfaces, where the first exposed part is exposed. Furthermore, the main body portion may have an outer surface extending in the first direction between the pair of intersecting surfaces. The first exposed region and the second exposed region may be exposed from a surface other than the outer surface of the main body portion. Here, the outer surface may be covered with a surface insulator portion.

In a case where the third exposed portion is provided, a first external electrode in contact with the first exposed part and a third external electrode in contact with the third exposed part may be provided outside the main body portion.

In the coil component including the second spiral conductor portion described above, the main body portion may have an outer surface extending in the first direction between the pair of intersecting surfaces. In this case, the first exposed region may have a second exposed part exposed from the outer surface, and the second exposed region may have a fourth exposed part exposed from the outer surface. In this case, at least one of the second exposed part and the fourth exposed part may be formed from a cut surface.

In the coil component including the second spiral conductor portion described above, the main body portion may have an outer surface extending in the first direction between the pair of intersecting surfaces. In this case, the first exposed region may have a third exposed part exposed from the intersecting surfaces, and a fourth exposed part connected to the third exposed part and exposed from the outer surface.

The coil component described above may have a fourth external electrode provided outside the main body portion and in contact with the fourth exposed part. In this case, the second exposed region may have a third exposed part exposed from the intersecting surfaces, and the fourth external electrode may extend so as to also contact the third exposed part.

In the coil component including the second spiral conductor portion described above, the second protrusion part may protrude further than the second spiral conductor portion on both sides in the first direction.

In the coil component including the second spiral conductor portion described above, the first protrusion part may protrude further than the first spiral conductor portion on one side in the first direction, and the second protrusion part may protrude on the same side in the first direction as the side to which the first protrusion part protrudes.

In the coil component including the second spiral conductor portion described above, the second connecting conductor portion may extend from an outer end of the pair of end parts of the second spiral conductor in a direction intersecting the first direction, and may include a second base portion facing the second protrusion part at one end in the first direction, and a second end via conductor portion electrically connecting the second protrusion part and the second base portion. In this case, in the second protrusion part, a position in the first direction where the cross-sectional area perpendicular to the first direction is minimal may be closer to the second end via conductor portion than a position in the first direction where the cross-sectional area perpendicular to the first direction is maximal. The second exposed region may have a third exposed part exposed from the intersecting surfaces, and a cross section of the second protrusion part perpendicular to the first direction may have a maximal area at the second exposed part.

In the coil component including the first spiral conductor portion, the second spiral conductor portion, and the via conductor portion having a portion formed by a continuous body, the coil conductor portion may have a portion formed by a laminated structure, which includes a first conductor portion and a second conductor portion provided on a surface of the first conductor portion.

In this case, the first conductor portion located in the second spiral conductor portion and the second conductor portion located in the second connecting conductor portion may form a continuous body. The second exposed region may include a third exposed part exposed from the intersecting surfaces. The second conductor portion may also be located in the third exposed part. Alternatively, the surface of the first conductor portion may have a first surface facing the first direction and a second surface extending along the first direction. The second conductor portion may be provided on both the first surface and the second surface.

In the coil component having the second spiral conductor portion described above, the coil component may further include a surface insulator portion covering at least a part of the surface of the main body portion.

In this case, the surface insulator portion may be made of an insulating resin, and the main body portion may contain a metal magnetic powder as the magnetic powder. In this case, the surface insulator portion may contain the metal magnetic powder, and the area of the metal magnetic powder in a cross section of the surface insulator portion may be 50% or less of the area of the metal magnetic powder in a cross section of the main body portion.

In the above coil component described above, in which the main body portion has the outer surface extending in the first direction between the pair of intersecting surfaces, the dimension of the second exposed part in a direction perpendicular to the first direction may be 200 μm or more.

In the above coil component described above, in which the main body portion has the outer surface extending in the first direction between the pair of intersecting surfaces, the dimension of the fourth exposed part in a direction perpendicular to the first direction may be 200 μm or more.

In the coil component described above, the first conductor portion may be a plated deposit, or the first conductor portion may be a continuous body.

In another aspect, the present invention provides a method for manufacturing a coil component. The coil component includes a coil member. The coil member includes a coil conductor portion. The coil conductor portion includes a first spiral conductor portion. The first spiral conductor portion includes turns of a spiral shape when viewed in a first direction.

The coil component is manufactured by including a pattern forming step and a plating step. The pattern forming step includes forming a first conductor pattern, which is a pattern of a conductive layer, on a first substrate surface, which is a surface of an insulating sheet substrate. The plating step including applying an electric current to the conductive layer to perform an electroplating process, forming a first plated deposit on the first conductor pattern, and forming a first conductor portion containing at least a portion of the first spiral conductor portion. The first conductor pattern includes a first portion pattern having a spiral shape corresponding to the first spiral conductor portion, and a second portion pattern having a circle equivalent diameter of at least 1.5 times a minimal width of spiral-shaped turns of the first portion pattern. The first conductor portion includes a first plated portion and a second plated portion. The first plated portion is formed in the first portion pattern and forms at least a part of the first spiral conductor portion, and the second plated portion is formed in the second portion pattern. The maximal length of the second plated portion in the first direction is 1.2 times or more the maximal length of the first plated portion in the first direction. This manufacturing method makes it possible to stably form the first protrusion part of the coil component.

In the above manufacturing method, the first portion pattern and the second portion pattern may be continuous on the first substrate surface. In the manufacturing method described above, the first conductor pattern may have a plurality of the first portion patterns and the second portion patterns, and the first conductor pattern may have a third portion pattern that satisfies at least one of the following: two of the first portion patterns are connected on the first substrate surface; two of the second portion patterns are connected on the first substrate surface; and one of the first portion patterns and one of the second portion patterns are connected on the first substrate surface. The first conductor portion formed by a first plating step may have a third plated portion formed on the third portion pattern.

In the manufacturing method described above, the manufacturing method may further include a shape forming step including supplying a material containing a magnetic powder to at least both sides of the first plated portion in the first direction and forming the material into a plate material.

In the manufacturing method described above, the shape forming step may include applying a pressure to compress the material containing the magnetic powder in at least the first direction, and a portion based on the second plated portion may be exposed from at least one surface of the plate material in the first direction.

In the manufacturing method described above, the manufacturing method further includes a cutting step of cutting the plate material obtained in the shape forming step in a manner that the first direction is parallel to a cut surface to form a first member. The first member includes the coil conductor portion and a main body portion. The main body portion includes the magnetic powder arranged on both sides of the first spiral conductor portion in the first direction, and a cut surface of the first member may expose a cut surface of the first conductor portion. In this case, a cut surface of the second plated portion may be exposed on the cut surface of the first member.

In the manufacturing method described above, the manufacturing method may further include, after the cutting step, an external electrode forming step of forming an external electrode, which is exposed from the first member and contacts at least a portion of the exposed conductor portion electrically connected to the first spiral conductor portion.

In the manufacturing method described above, the first conductor pattern has a second portion pattern, which is not continuous with the first portion pattern on the first substrate surface but is connected thereto on the first substrate surface via the third portion pattern. The first plated portion formed on the first portion pattern and the second plated portion formed on the second portion pattern may be included in the first member.

In the manufacturing method described above, the first member may or may not include the third plated portion.

In the manufacturing method described above, the manufacturing method may further include a second plating step prior to the shape forming step, in which a plating layer made of a second plated deposit is formed on the exposed surface of the first plated deposit by plating.

In the manufacturing method described above, in the pattern forming step, the first conductor pattern may be formed by arranging an insulating negative pattern having an inverted shape of the first conductor pattern on the conductive layer. In the first plating step, the electroplating process may be performed using the negative pattern as a masking material. In this case, after the first plating step, the negative pattern is peeled off, and a peeling step may be further provided to peel off the conductive layer exposed in the first direction. Furthermore, the conductive layer may be made of a material having etching characteristics different from those of the first plated deposit.

In the manufacturing method described above, the first plated deposit may be made of a material containing Cu, and the second plated deposit may be made of a material containing Cu.

In the manufacturing method described above, the manufacturing method may further include, at least after the first plating step, a sheet removal step of removing the sheet substrate in a region surrounded by an inner edge of the first spiral conductor portion when viewed in the first direction.

In the manufacturing method described above, the manufacturing method may further include a covering step, prior to the shape forming step, of disposing an insulating material so as to cover at least partially an exposed portion of a conductor body obtained through at least the first plating step.

In the manufacturing method described above, the coil conductor portion has spiral-shaped turns. The coil conductor portion includes a second spiral conductor portion arranged alongside in the first direction with the first spiral conductor portion, and a via conductor portion in contact with one end of the first spiral conductor portion and one end of the second spiral conductor portion to electrically connect the first spiral conductor portion and the second spiral conductor portion in the first direction. The sheet substrate may have a first substrate through hole corresponding to the via conductor portion. In this case, in the pattern forming step, a second conductor pattern, which is a pattern of the conductive layer, is formed on a second substrate surface. The second substrate surface is a surface of the sheet substrate opposite to the first substrate surface. Meanwhile, an in-hole conductive layer electrically connecting the first conductor pattern and the second conductor pattern is formed inside the first substrate through hole. In the first plating step, the first plated deposit is formed on the in-hole conductive layer by the electroplating process to form the via conductor portion. Meanwhile, a second conductor portion made of the first plated deposit and including at least a part of the second spiral conductor portion is formed on the second conductor pattern. The second conductor pattern includes a fourth portion pattern having a spiral shape corresponding to the second spiral conductor portion, and a fifth portion pattern having a circle equivalent diameter, which is 1.5 times or more a minimal width of spiral-shaped turns of the fourth portion pattern. The second conductor portion includes a fourth plated portion formed in the fourth portion pattern and forming at least a part of the second spiral conductor portion, and a fifth plated portion formed in the fifth portion pattern. The maximal value of the length of the fifth plated portion in the first direction is 1.2 times or more the maximal value of the length of the fourth plated portion in the first direction. In the shape forming step, a material containing the magnetic powder is supplied to at least both sides of the first plated portion and the fourth plated portion in the first direction. The main body portion included in the first member formed in the cutting step includes the magnetic powder arranged on both sides of the first spiral conductor portion and the second spiral conductor portion in the first direction. The cut surface of the first conductor portion and a cut surface of the second conductor portion may be exposed on the cut surface of the first member.

In this case, the fourth portion pattern and the fifth portion pattern may be continuous on the second substrate surface. Alternatively, the second conductor pattern may have a plurality of the fourth portion patterns and the fifth portion patterns, and the second conductor pattern may have a sixth portion pattern that satisfies at least one of the following: two of the fourth portion patterns are connected on the second substrate surface; two of the fourth portion patterns are connected on the second substrate surface; and one of the fourth portion patterns and one of the fifth portion patterns are connected on the second substrate surface. The second conductor portion formed by the first plating step may have a sixth plated portion formed on the sixth portion pattern.

Here, the shape forming step may include applying a pressure to compress the material containing the magnetic powder in at least the first direction. A portion based on the second plated portion and a portion based on the fifth plated portion may be exposed from at least one surface of the plate material in the first direction. Furthermore, a cut surface of the fifth plated portion may be exposed on the cut surface of the first member. The first member may not include the sixth plated portion.

In the case where the fourth portion pattern and the fifth portion pattern are included, the second conductive pattern includes the fifth portion pattern, which is not continuous with the fourth portion pattern on the second substrate surface but is connected thereto on the second substrate surface via the sixth portion pattern. The fourth plated portion formed on the fourth portion pattern and the fifth plated portion formed on the fifth portion pattern may be included in the first member. Alternatively, the first portion pattern and the second portion pattern are continuous on the first substrate surface, and the fourth portion pattern and the fifth portion pattern are not continuous on the second substrate surface. The sheet substrate has the second substrate through hole, in which the conductive layer is provided. The second portion pattern and the fifth portion pattern are connected via the conductive layer disposed in the second substrate through hole. The second plated portion and the fifth plated portion may form a continuous structure via the first plated deposit formed in the second substrate through hole during the first plating step. The first member may include the sixth plated portion.

The present invention, in another aspect, provides an electronic/electric device, installed therein the coil component described above. The coil component provides an electronic/electric device, in which the coil conductor portion is connected to a substrate via terminal members provided on exposed conductor portions respectively located at the two end parts of the coil conductor portion and exposed from the external. As examples of the electronic/electric devices, a power supply device including a power switching circuit, a voltage step-up/step-down circuit, and a smoothing circuit, as well as a compact portable communication device, can be given. Since the electronic/electric device according to the present invention includes the above-described coil component, it exhibits excellent comprehensive characteristics as an inductance element.

### Effect of the Invention

According to the present invention, a coil component is provided, wherein conductor resistance of the coil component is less likely to increase, resulting in superior electrical characteristics. When the coil component is incorporated into an electronic/electric device, it can enhance the performance of the device or reduce its dimensions. Furthermore, according to the present invention, an electronic/electric device incorporating the coil component is provided. Additionally, a method for manufacturing the aforementioned coil component is also provided.

### BRIEF DESCRIPTION OF THE DRAWINGS

FIG. 1 is a perspective view conceptually illustrating the shape of a coil component according to an embodiment of the present invention.

FIG. 2 is a diagram illustrating the structure of a coil conductor portion provided in the coil component according to an embodiment of the present invention.

FIG. 3 is an XY plan view illustrating the structure of a first spiral conductor portion provided in the coil component according to an embodiment of the present invention.

FIG. 4 is an XY plan view illustrating the structure of a second spiral conductor portion provided in the coil component according to an embodiment of the present invention.

FIG. 5 is an XZ cross-sectional view taken along line A-A′ in FIG. 3 and FIG. 4.

FIG. 6 is an enlarged view of the region enclosed by the broken line in FIG. 5.

FIG. 7 is an explanatory diagram (Part 1) of an example of a manufacturing method for the coil component according to an embodiment of the present invention.

FIG. 8 is an explanatory diagram (Part 2) of an example of a manufacturing method for the coil component according to an embodiment of the present invention.

FIG. 9A is an explanatory diagram (Part 3) of an example of a manufacturing method for the coil component according to an embodiment of the present invention.

FIG. 9B is a diagram illustrating a test pattern.

FIG. 9C is a graph showing test results using the test pattern.

FIG. 10 is an explanatory diagram (Part 4) of an example of a manufacturing method for the coil component according to an embodiment of the present invention.

FIG. 11 is an explanatory diagram (Part 5) of an example of a manufacturing method for the coil component according to an embodiment of the present invention.

FIG. 12 is an explanatory diagram (Part 6) of an example of a manufacturing method for the coil component according to an embodiment of the present invention.

FIG. 13 is an explanatory diagram (Part 7) of an example of a manufacturing method for the coil component according to an embodiment of the present invention.

FIG. 14A is an explanatory diagram (Part 8) of an example of a manufacturing method for the coil component according to an embodiment of the present invention.

FIG. 14B is a diagram illustrating a coil array.

FIG. 14C is a diagram illustrating a coil array sheet.

FIG. 15 is an explanatory diagram (Part 9) of an example of a manufacturing method for the coil component according to an embodiment of the present invention.

FIG. 16A is an explanatory diagram (Part 10) of an example of a manufacturing method for the coil component according to an embodiment of the present invention.

FIG. 16B is a diagram illustrating a cutting step for the coil array.

FIG. 17 is an explanatory diagram (Part 11) of an example of a manufacturing method for the coil component according to an embodiment of the present invention.

FIG. 18A is an explanatory diagram (Part 12) of an example of a manufacturing method for the coil component according to an embodiment of the present invention.

FIG. 18B is a diagram illustrating a modified example of the external electrode forming step.

FIG. 19 is an explanatory diagram (XZ cross-sectional view) illustrating a first one of other examples of the coil component according to an embodiment of the present invention.

FIG. 20A is an explanatory diagram (XZ cross-sectional view) illustrating a second one of other examples of the coil component according to an embodiment of the present invention.

FIG. 20B is an explanatory diagram (perspective view) illustrating the second one of other examples of the coil component according to an embodiment of the present invention.

FIG. 20C is an explanatory diagram (plan view) illustrating the second one of other examples of the coil component according to an embodiment of the present invention.

FIG. 20D is an explanatory diagram (bottom view) illustrating the second one of other examples of the coil component according to an embodiment of the present invention.

FIG. 20E is an explanatory diagram (plan view of coil array) illustrating the second one of other examples of the coil component according to an embodiment of the present invention.

### DETAILED DESCRIPTION

Below, embodiments according to the present invention will be described in detail with reference to the drawings.

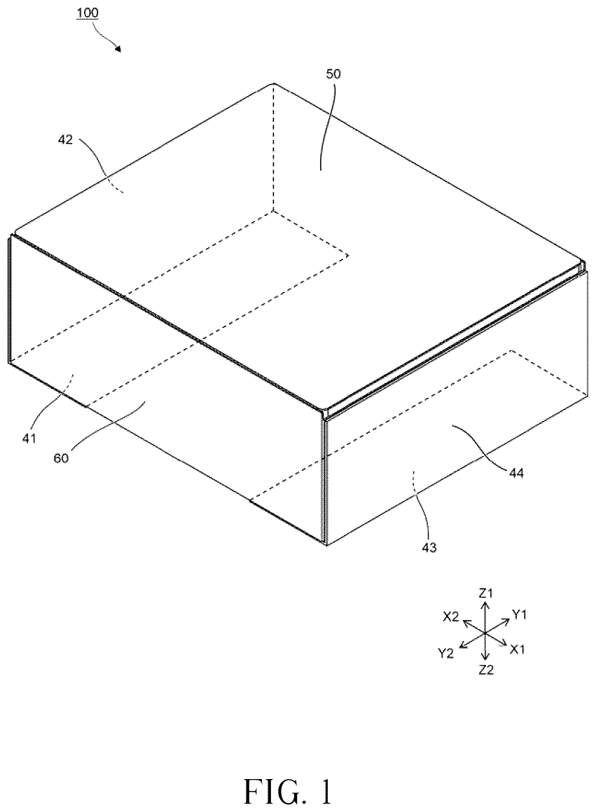

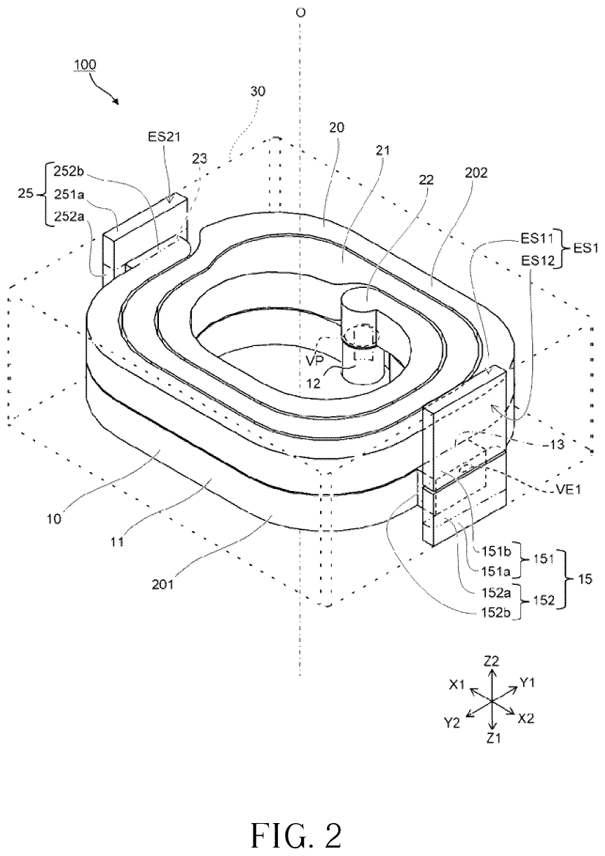

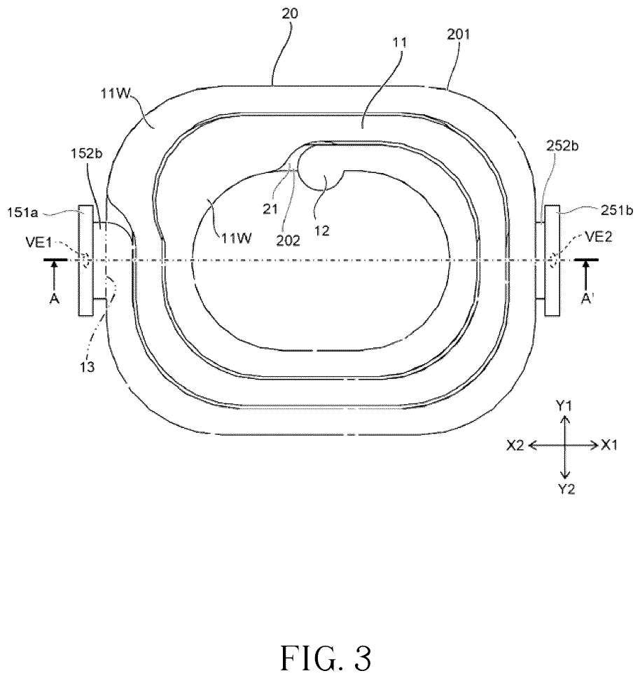

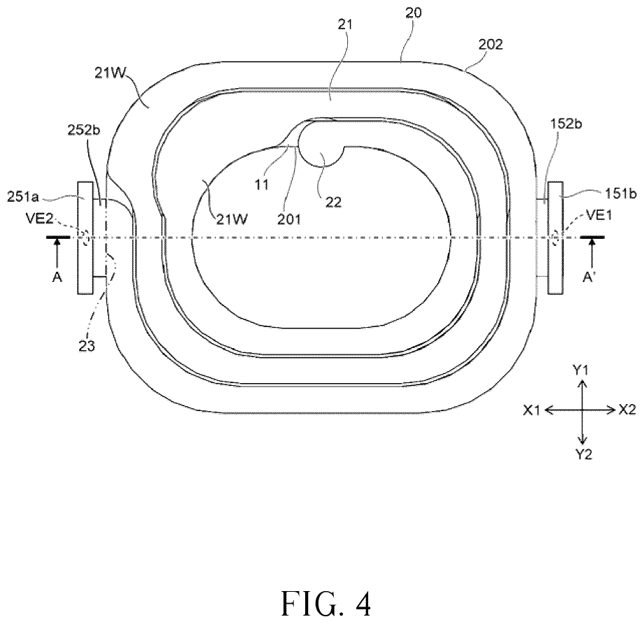

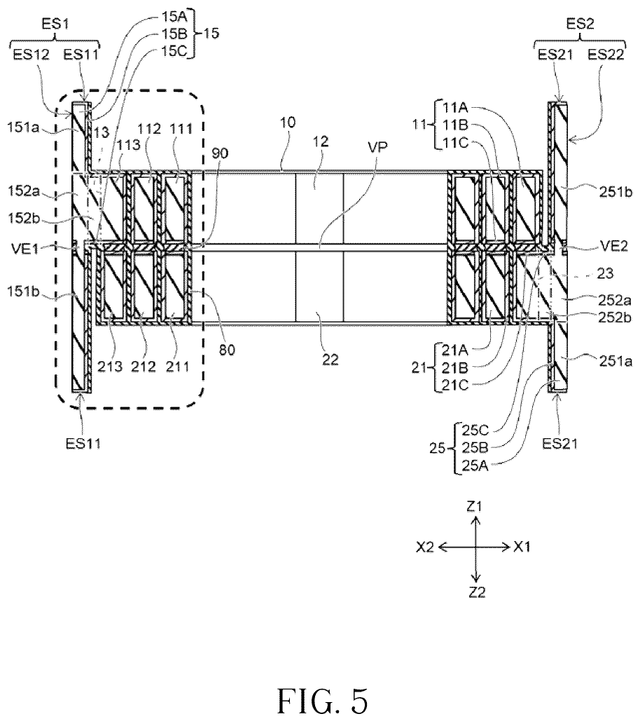

FIG. 1 is a perspective view conceptually illustrating the shape of a coil component according to an embodiment of the present invention. FIG. 2 is a diagram illustrating the structure of a coil conductor portion provided in the coil component according to an embodiment of the present invention. In FIG. 2, for convenience of explanation, the coil conductor portion is drawn with solid lines, the main body portion is drawn with broken lines, and other components are omitted. In addition, compared with FIG. 1, the state shown in FIG. 2 is rotated 180° about the Y1-Y2 axis. FIG. 3 is an XY plan view illustrating the structure of a first spiral conductor portion provided in the coil component according to an embodiment of the present invention. FIG. 4 is an XY plan view illustrating the structure of a second spiral conductor portion provided in the coil component according to an embodiment of the present invention. FIG. 5 is an XZ cross-sectional view taken along line A-A′ in FIG. 3 and FIG. 4. FIG. 2 is a view from the Z2 side in the Z1-Z2 direction, FIG. 3 shows only the coil conductor portion as viewed from the Z1 side in the Z1-Z2 direction, and FIG. 4 shows only the coil conductor portion as viewed from the Z2 side in the Z1-Z2 direction.

### (Overall Configuration)

The coil component 100 according to an embodiment of the present invention includes a coil member 10 having a coil conductor portion 20, a main body portion 30, a first external electrode 41, a second external electrode 42, a third external electrode 43, a fourth external electrode 44, and outer covers 50 and 60.

### (Coil)

As shown in FIG. 2 and FIG. 3, the coil member 10 includes a coil conductor portion 20 having a first coil conductor portion 201. The first coil conductor portion 201 includes a first spiral conductor portion 11 having a spiral shape around an axis O extending along a first direction (Z1-Z2 direction), from an inner end part 12 located on the inner side of a pair of ends of the first spiral conductor portion 11 toward an outer end part 13 located on the outer side of the pair of ends, revolving away from the axis O. In FIG. 3, the first spiral conductor portion 11 is arranged such that, when viewed from the Z1 side in the Z1-Z2 direction, a spiral-shaped conductor revolves clockwise from the inner end part 12 toward the outer end part 13, moving away from the axis O. In this specification, the term “spiral direction” refers to the direction from the inner end part toward the outer end part in the spiral portion.

The conductor (conductive material) forming the coil conductor portion 20 is not particularly limited as long as it has suitable conductivity. Examples include metals such as copper, copper alloys, aluminum, and aluminum alloys. The coil conductor portion 20 can be manufactured using film-forming techniques such as plating. The coil member 10 has a coil insulator portion (not shown in FIG. 1 to FIG. 4) on the surface of the coil conductor portion 20. This coil insulator portion ensures insulation between adjacent conductors (between opposing conductor surfaces) in the coil conductor portion 20. The coil insulator portion may be formed of a resin material. The two ends of the coil conductor portion 20 (the first connecting conductor portion 15 and the second connecting conductor portion 25) do not have the coil insulator portion, so the coil member 10 can be electrically connected to other members at these ends.

Here, the term “turn width” is defined to be a distance, when viewed in the first direction (Z1-Z2 direction), between any point on the side surface forming the inner periphery of a turn of the first spiral conductor portion 11 and the point where a line normal to that point (perpendicular to the first direction) intersects the side surface forming the outer periphery of the turn is defined as the “turn width”. The first spiral conductor portion 11 has a turn widening portion 11W where the turn width is wider than other regions. The maximal value of the turn width in the turn widening portion 11W may be, for example, 1.5 times or more and 3.0 times or less the turn width of a region adjoining to the turn widening portion 11W. The upper limit may be 2.5 times. In the turn widening portion 11W, since the turn width is relatively wide, the resistance is likely loared. Therefore, the coil component 100 having the first spiral conductor portion 11 with the turn widening portion 11W tends to have a lower direct current resistance (DCR). The definition of turn width also applies to the width of turns appearing during the manufacturing process of the first spiral conductor portion 11 (for example, the pattern of the conductive layer 55).

As shown in FIG. 4, the coil conductor portion 20 includes a second coil conductor portion 202 having a second spiral conductor portion 21 arranged alongside the first spiral conductor portion 11 in the first direction. The second spiral conductor portion 21 has a spiral shape around the axis O extending along the first direction (Z1-Z2 direction), from one end part (inner end part 22) located on the inner side toward the other end pat (outer end part 23) located on the outer side, revolving away from the axis O. When viewed from the Z1 side in the Z1-Z2 direction, the second spiral conductor portion 21 revolves in the opposite direction to the first spiral conductor portion 11 (counterclockwise in FIG. 2), moving away from the axis O. The second spiral conductor portion 21 also has a turn widening portion 21W similar to the first spiral conductor portion 11.

The average gap distance in the first direction (Z1-Z2 direction) between the first spiral conductor portion 11 and the second spiral conductor portion 21 is not particularly limited. A smaller gap distance tends to reduce the height (dimension in the Z1-Z2 direction) of the coil component 100, but if the distance is excessively small, insulation between the first spiral conductor portion 11 and the second spiral conductor portion 21 may deteriorate. From the perspective of achieving both a low profile and high insulation, the gap distance is preferably 0.4 μm or more and 20 μm or less. More preferably, the gap distance is 1.0 μm or more, and even more preferably 5.0 μm or more, to reduce variation and ensure stable support during manufacturing.

The inner end part 12 of the first spiral conductor portion 11 and the inner end part 22 of the second spiral conductor portion 21 are electrically connected by a via member VP. Starting from a portion connecting to the via member VP, the first spiral conductor portion 11 and the second spiral conductor portion 21 spiral in opposite directions. The via member VP may be formed of the same conductor as the coil conductor portion 20. In one example, the via member VP is manufactured together with the first spiral conductor portion 11 and the second spiral conductor portion 21 in the same process. In this case, the via member VP is integrated with the inner end parts 12 and 22.

The outer end part 13 of the first spiral conductor portion 11 is continuously connected to the first connecting conductor portion 15 as part of the first coil conductor portion 201, and the outer end part 23 of the second spiral conductor portion 21 is continuously connected to the second connecting conductor portion 25 as part of the second coil conductor portion 202. Therefore, the outer end part 13 of the first spiral conductor portion 11 substantially forms an interface with the first connecting conductor portion 15, and the outer end part 23 of the second spiral conductor portion 21 substantially forms an interface with the second connecting conductor portion 25. In one example, the first connecting conductor portion 15 and the second connecting conductor portion 25 are manufactured together with the first spiral conductor portion 11 and the second spiral conductor portion 21 in the same process. In this case, each connecting conductor portion is integrated with its corresponding outer end part without a boundary.

In other words, in this embodiment, the coil conductor portion 20 includes the first coil conductor portion 201 having the first spiral conductor portion 11 and the first connecting conductor portion 15, and the second coil conductor portion 202 having the second spiral conductor portion 21 and the second connecting conductor portion 25, as well as the via member VP, a first end via conductor portion VE1 and a second end via conductor portion VE2 (described later). These are manufactured to have integrated portions (specifically portions formed of the first conductive material) through a common manufacturing process.

As shown in FIG. 5, the turns of the first spiral conductor portion 11 and the turns of the second spiral conductor portion 21 are arranged alongside in the first direction (Z1-Z2 direction). The first spiral conductor portion 11 includes a first inner-side turn 111 located at the innermost periphery, a first outer-side turn 113 located at the outermost periphery, and a first central turn 112 located between them. The second spiral conductor portion 21 includes a second inner-side turn 211 located at the innermost periphery, a second outer-side turn 213 located at the outermost periphery, and a second central turn 212 located between them.

The second inner-side turn 211 is positioned on the Z2 side of the first inner-side turn 111 in the Z1-Z2 direction, the second outer-side turn 213 is positioned on the Z2 side of the first outer-side turn 113, and the second central turn 212 is positioned on the Z2 side of the first central turn 112.

### (Main Body Portion)

The main body portion 30 covers the first spiral conductor portion 11 and the second spiral conductor portion 21 with a pair of intersecting surfaces arranged alongside in the first direction (Z1-Z2 direction) and contains magnetic powder. In this embodiment, the main body portion 30 has four outer surfaces extending in the first direction between the pair of intersecting surfaces and has a substantially rectangular parallelepiped shape. The main body portion 30 encloses portions other than the end faces located at the ends of the coil member 10, specifically the outermost ends of the first connecting conductor portion 15 (on the X2 side in the X1-X2 direction and on both sides in the Z1-Z2 direction) and the outermost ends of the second connecting conductor portion 25 (on the X1 side in the X1-X2 direction and on both sides in the Z1-Z2 direction).

### (Connecting Conductor Portion)

Hereinafter, the first connecting conductor portion 15 and the second connecting conductor portion 25 will be described in detail with reference to FIG. 2 and FIG. 5. FIG. 5 is an XZ cross-sectional view taken along line A-A′ in FIGS. 3 and 4. In the following description, the Z1 side in the Z1-Z2 direction may be referred to as the upper side, and the Z2 side in the Z1-Z2 direction may be referred to as the lower side. The lower side is the side where the first external electrode 41 and the third external electrode 43, described later, extend, and corresponds to the mounting surface side when the coil component 100 is used.

The first connecting conductor portion 15 has a first protrusion part 151 protruding further than the first spiral conductor portion 11 toward at least one side in the first direction (Z1-Z2 direction). In the example shown in FIG. 2 and FIG. 5, the first protrusion part 151 protrudes further than the first spiral conductor portion 11 on both sides in the first direction (Z1-Z2 direction), and includes a first upper protrusion part 151a protruding toward the upper side (Z1 side in the Z1-Z2 direction) and a first lower protrusion part 151b protruding toward the lower side (Z2 side in the Z1-Z2 direction).

The first connecting conductor portion 15 includes a first base portion 152 and a first end via conductor portion VE1. The first base portion 152 extends from the outer end part 13 of the first spiral conductor portion 11 in a direction intersecting the first direction, namely toward the X2 side in the X1-X2 direction, between the first upper protrusion part 151a and the first lower protrusion part 151b. The first end via conductor portion VE1 is electrically connected to the first protrusion part 151, and specifically to the first lower protrusion part 151b, and the first base portion 152. In this embodiment, the first base portion 152 includes a first outer base portion 152a directly facing the first protrusion part 151 in the first direction, and a first inner base portion 152b located between the outer end part 13 of the first spiral conductor portion 11 and the first outer base portion 152a.

The first connecting conductor portion 15 has a first exposed region ES1 exposed from the main body portion 30. As shown in FIG. 2 and FIG. 5, the first exposed region ES1 includes a first exposed part ES11 exposed from the intersecting surfaces of the main body portion 30 (two surfaces facing Z1-Z2 direction) and a second exposed part ES12 exposed from one of the outer surfaces of the main body portion 30 (surface on X2 side in X1-X2 direction). The second exposed part ES12 may be formed from a cut surface.

In this embodiment, the first exposed part ES11 includes an end face of an upper side (Z1 side in Z1-Z2 direction) of the first upper protrusion part 151a and an end face of a lower side (Z2 side in Z1-Z2 direction) of the first lower protrusion part 151b. The second exposed part ES12 includes end faces of the first upper protrusion part 151a, the first outer base portion 152a, and the first lower protrusion part 151b on the X2 side in the X1-X2 direction. In this embodiment, the first end via conductor portion VE1 is not exposed from the main body portion 30, but it may be exposed and form part of the second exposed part ES12.

In this embodiment, the first protrusion part 151 has a portion formed by a continuous body extending in the first direction (Z1-Z2 direction). The first protrusion part 151, the first end via conductor portion VE1, and the first base portion 152 have a portion formed by a continuous body extending in the first direction. As described above, the term “portion formed by a continuous body” refers to a series of parts manufactured by a single shape forming process (a specific example is a plating process) and having no particular bonding interface. Since the first base portion 152 has a portion formed by a continuous body extending from the outer end part 13 of the first spiral conductor portion 11 without a bonding interface, there is no interface based on the manufacturing process from the outer end part 13 of the first spiral conductor portion 11 up to the first exposed part ES11. Therefore, the coil component 100 according to this embodiment is less likely to experience an increase in direct current resistance (DCR).

A second connecting conductor portion 25 has a second protrusion part 251 (251a, 251b) protruding further than the second spiral conductor portion 21 toward at least one side in the first direction (Z1-Z2 direction). In the example shown in FIG. 2 and FIG. 5, the second protrusion part 251 protrudes further than the second spiral conductor portion 21 on both sides in the first direction (Z1-Z2 direction), and includes a second upper protrusion part 251b protruding toward the upper side (Z1 side in the Z1-Z2 direction) and a second lower protrusion part 251a protruding toward the lower side (Z2 side in the Z1-Z2 direction).

The second connecting conductor portion 25 includes a second base portion 252 and a second end via conductor portion VE2. The second base portion 252 extending from the outer end part 23 of the second spiral conductor portion 21 in a direction intersecting the first direction, namely toward the X1 side in the X1-X2 direction, between the second upper protrusion part 251b and the second lower protrusion part 251a. The second end via conductor portion VE2 is electrically connected the second protrusion part 251, and specifically to the second upper protrusion part 251b, and the second base portion 252. In this embodiment, the second base portion 252 includes a second outer base portion 252a directly facing the second protrusion part 251 in the first direction, and a second inner base portion 252b located between the outer end part 23 of the second spiral conductor portion 21 and the second outer base portion 252a.

The second connecting conductor portion 25 has a second exposed region ES2 exposed from the main body portion 30. As shown in FIG. 2 and FIG. 5, the second exposed region ES2 includes a third exposed part ES21 exposed from the intersecting surfaces of the main body portion 30 (two surfaces facing the Z1-Z2 direction) and a fourth exposed part ES22 exposed from one of the outer surfaces of the main body portion 30 (the surface on the X1 side in the X1-X2 direction). The fourth exposed part ES22 may be formed from a cut surface.

In this embodiment, the third exposed part ES21 includes an end face of an upper side (Z1 side in Z1-Z2 direction) of the second upper protrusion part 251b and an end face of a lower side (Z2 side in Z1-Z2 direction) of the second lower protrusion part 251a. The fourth exposed part ES22 includes end faces of the second upper protrusion part 251b, the second outer base portion 252a, and the second lower protrusion part 251a on the X1 side in the X1-X2 direction. In this embodiment, the second end via conductor portion VE2 is not exposed from the main body portion 30, but it may be exposed and form part of the fourth exposed part ES22.

In this embodiment, the second protrusion part 251 has a portion formed by a continuous body extending in the first direction (Z1-Z2 direction). The second protrusion part 251, the second end via conductor portion VE2 and the second base portion 252 have a portion formed by a continuous body extending in the first direction. Since the second base portion 252 has a portion formed by a continuous body extending from the outer end part 23 of the second spiral conductor portion 21 without a bonding interface, there is no interface based on the manufacturing process between the outer end part 23 of the second spiral conductor portion 21 and the third exposed part ES21. Therefore, the coil component 100 according to this embodiment is less likely to experience an increase in direct current resistance (DCR).

In this embodiment, in the first protrusion part 151, the position in the first direction (Z1-Z2 direction) where the cross-sectional area (XY plane) perpendicular to the first direction is minimal may be closer to the first end via conductor portion VE1 than the position in the first direction where the cross-sectional area perpendicular to the first direction is maximal. In this case, the amount of magnetic powder near the coil member 10 can be increased, and the inductance L and the DC superimposition rated current Isat can be maintained at relatively high levels. Furthermore, in the first protrusion part 151, the cross-sectional area (XY plane) perpendicular to the first direction may be maximal at the first exposed part ES11. In this case, the contact area with the first external electrode 41 becomes relatively large, so the contact resistance between the first exposed part ES11 and the first external electrode 41, which will be described later, can be reduced.

### (External Electrode)

As shown in FIG. 1, the coil component 100 according to this embodiment has external electrodes provided outside the main body portion 30 as terminal members of the coil component 100. In other words, the external electrodes are provided on exposed conductor portions where the coil conductor portion 20 is exposed outwards. Specifically, the external electrodes includes a first external electrode 41 in contact with the end face of the first lower protrusion part 151b of the first exposed part ES11, a second external electrode 42 in contact with the second exposed part ES12, a third external electrode 43 in contact with the end face of the second lower protrusion part 251a of the third exposed part ES21, and a fourth external electrode 44 in contact with the fourth exposed part ES22. The first external electrode 41 and the second external electrode 42 may be electrically connected to each other outside the main body portion 30, and the third external electrode 43 and the fourth external electrode 44 may also be electrically connected to each other outside the main body portion 30. In other words, the second external electrode 42 may extend to contact the end face of the first lower protrusion part 151b of the first exposed part ES11, and the fourth external electrode 44 may extend to contact the end face of the second lower protrusion part 251a of the third exposed part ES21.

The material and structure of the first external electrode 41 and the second external electrode 42 are not particularly limited as long as they have suitable conductivity. One non-limiting example of the first external electrode 41 and the second external electrode 42 includes a layer having a structure of Cu plating/Ni plating/Sn plating from a side near the surface of the main body portion 30. The first external electrode 41 and the second external electrode 42 may also be formed of a coating-type electrode in which a conductive substance such as silver is dispersed in a resin. Furthermore, the first external electrode 41 and the second external electrode 42 may be a type of electrode with combined plating and coating. The third external electrode 43 and the fourth external electrode 44 are similar to the first external electrode 41 and the second external electrode 42.

### (First Conductor Portion, Second Conductor Portion, Conductive Layer)

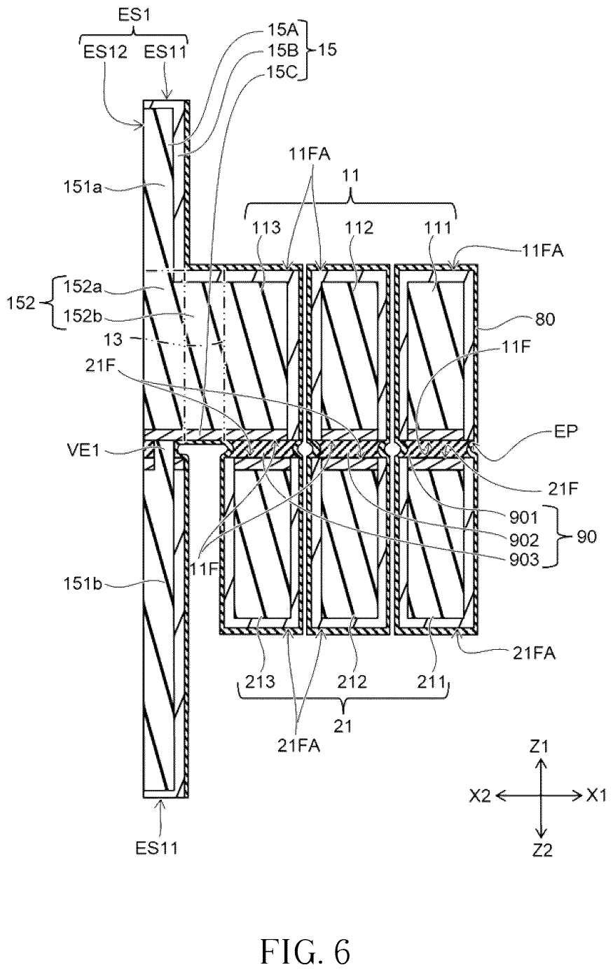

FIG. 6 is an enlarged view of the region enclosed by the broken line in FIG. 5.

As shown in FIG. 5, the first spiral conductor portion 11 includes a first conductor portion 11A, which extends along the spiral direction from the inner end part 12 to the outer end part 13 and is formed of a first conductive material, and a second conductor portion 11B, which is provided on the surface of the first conductor portion 11A and electrically connected thereto, and is formed of a second conductive material. In other words, the first spiral conductor portion 11 has a laminated structure including the first conductor portion 11A and the second conductor portion 11B. The surface of the first conductor portion 11A includes a first surface (XY plane) facing the first direction (Z1-Z2 direction), and a second surface (XZ plane, YZ plane) extending along the first direction. The second conductor portion 11B is provided on both the first surface and the second surface.

As described later, in one example, the first conductor portion 11A and the second conductor portion 11B are manufactured by different processes. In this case, even if they are made of the same material (for example, a material containing Cu such as copper or a copper alloy), they can be distinguished by cross-sectional observation because their microstructural characteristics such as crystal structure, crystal orientation, and crystal growth direction differ. In one specific example, the first conductor portion 11A is formed from an electroplated deposit (electrolytic plated deposit), and the second conductor portion 11B is formed from a plated deposit. The plated deposit may be an electroplated deposit or an electroless plated deposit. From the perspective of reducing the thickness of the second conductor portion 11B, it is preferable that the plated deposit is an electroplated deposit.

By making the first spiral conductor portion 11 be a multilayer structure, even if the first conductor portion 11A is subject to restrictions on its shape on the XY plane due to manufacturing requirements such as improving uniformity of formation height, the design flexibility for the shape on the XY plane of the first coil conductor portion 201 can be ensured by providing the second conductor portion 11B electrically connected to the surface of the first conductor portion 11A. Furthermore, is can be made easy to form a shape that is difficult to be stably formed by a method of forming a plated deposit on the exposed portion of a negative pattern 56P formed by photoresist, specifically a shape having a large aspect ratio (deposit height/gap width) between adjacent plated deposits.

Although the first conductor portion 11A and the second conductor portion 11B have been described above with respect to the first spiral conductor portion 11, in the coil component 100 according to this embodiment, the first connecting conductor portion 15 included in the first coil conductor portion 201 and the second spiral conductor portion 21 and the second connecting conductor portion 25 included in the second coil conductor portion 202 also have similar structures. In other words, the first conductor portion 15A formed of the first conductive material extends integrally in the X1-X2 direction from the outer end part 13 of the first spiral conductor portion 11 at the first base portion 152, and extends integrally in the Z1-Z2 direction with the first conductor portion 15A of the first base portion 152 at the first protrusion part 151. The first conductive material filling the first end via conductor portion VE1 is interposed integrally between the first outer base portion 152a and the first lower protrusion part 151b.

The second conductor portion 15B formed of the second conductive material is provided on the surface of the portion formed from the first conductor portion 15A, which faces the Z1-Z2 direction, at the first base portion 152, and on the surface of the portion formed from the first conductor portion 15, which faces the Z1-Z2 direction on the X1 side in the X1-X2 direction A, at the first protrusion part 151. They are integrally formed. Therefore, in this embodiment, the second conductor portion 15B is located in the first exposed part ES11 but not in the second exposed part ES12.

The first conductor portion 21A formed of the first conductive material and constituting the second spiral conductor portion 21 extends in the current flow direction and is integrated with the first conductor portion 11A constituting the first spiral conductor portion 11 via the first conductive material filling the via member VP at the inner end part 22 of the second spiral conductor portion 21. In this specification, the term “current flow direction” refers to the direction of current flow when the coil component 100 is energized. A second conductor portion 21B formed of the second conductive material is provided on the surface of the first conductor portion 21A.

The first conductor portion 25A formed of the first conductive material extends integrally in the X1-X2 direction from the outer end part 23 of the second spiral conductor portion 21 at the second base portion 252, and extends integrally in the Z1-Z2 direction with the first conductor portion 25A of the second base portion 252 at the second protrusion part 251. In other words, in the coil conductor portion 20, the portion formed of the first material exists as a continuous body in the first connecting conductor portion 15, the first end via conductor portion VE1, the first spiral conductor portion 11, the via member VP, the second spiral conductor portion 21, the second connecting conductor portion 25, and the second end via conductor portion VE2.

The second conductor portion 25B formed of the second conductive material is provided on the surface of the portion formed from the first conductor portion 25A, which faces the Z1-Z2 direction, at the second base portion 252, and on the surface of the portion formed of the first conductor portion 25A, which faces the Z1-Z2 direction on the X2 side in the X1-X2 direction, at the second protrusion part 251. They are integrally formed. Therefore, in this embodiment, the second conductor portion 25B is located in the third exposed part ES21 but not in the fourth exposed part ES22.

The first spiral conductor portion 11 includes a conductive layer 11C on the side facing the second spiral conductor portion 21 (Z2 side in Z1-Z2 direction) of the first conductor portion 11A, and the second spiral conductor portion 21 has a conductive layer 21C on the side facing the first spiral conductor portion 11 (Z1 side in Z1-Z2 direction) of the first conductor portion 21A. Similarly, the first base portion 152 has a conductive layer 15C extending toward the X2 side in the X1-X2 direction from the conductive layer 11C, and the second base portion 252 has a conductive layer 25C extending toward the X1 side in the X1-X2 direction from the conductive layer 21C. When the first conductor portions 11A, 21A, 15A, and 25A are formed by a plating process, the conductive layers 11C, 21C, 15C, and 25C can be used as seed layers for forming plated deposits. Furthermore, by arranging the conductive layer 11C and the conductive layer 21C to face each other, the gap distance between the first spiral conductor portion 11 and the second spiral conductor portion 21 can be appropriately set, and insulation between them can be properly ensured.

### (First Insulator Portion)

As shown in FIG. 5, the coil insulator portion includes a first insulator portion 90 that contacts at least partially one end part of the first spiral conductor portion 11 in the first direction, specifically the end part on the side facing the second spiral conductor portion 21 (Z2 side in Z1-Z2 direction). The first insulator portion 90 shown in FIG. 5 also contacts at least partially one end part of the second spiral conductor portion 21 in the first direction, specifically the end part on the side facing the first spiral conductor portion 11 (Z1 side in Z1-Z2 direction), on the opposite side (Z2 side) from the side contacting the first spiral conductor portion 11. In other words, the first insulator portion 90 is interposed between the first spiral conductor portion 11 and the second spiral conductor portion 21 arranged in the first direction and contacts both.

By contacting the first spiral conductor portion 11, the first insulator portion 90 ensures reliable insulation of the first spiral conductor portion 11. Furthermore, as shown in FIG. 5, by contacting both the first spiral conductor portion 11 and the second spiral conductor portion 21, the first insulator portion 90 stably prevents short-circuiting between the two spiral conductor portions.

The material constituting the first insulator portion 90 is not particularly limited as long as it has suitable insulating properties. Preferably, the first insulator portion 90 has a volume resistivity of 1.0×10¹⁴ Ω·cm or more as measured by ASTM D257. More preferably, the volume resistivity is 1.0×10¹⁵ Ω·cm or more, and even more preferably 1.0×10¹⁶ Ω·cm or more. The upper limit of the volume resistivity is not particularly limited and may be 1.0×10²⁰ Ω·cm or less. The first insulator portion 90 preferably has excellent dielectric properties, specifically a relative permittivity at 60 Hz of 4.0 or less as measured by ASTM D150. More preferably, the relative permittivity is 3.5 or less, and even more preferably 3.0 or less. The lower limit of the relative permittivity is not particularly limited and may be 1.0 or more. The methods for measuring volume resistivity and relative permittivity are not limited as long as they provide results equivalent to those obtained by ASTM D257 and D150. For example, a test sample prepared from a material equivalent to the first insulator portion 90 may be analyzed using component analysis or FT-IR to identify the material and evaluate its properties such as volume resistivity.

The material constituting the first insulator portion 90 may be an organic material, an inorganic material, or a composite material of organic and inorganic materials. When the first insulator portion 90 is formed of a composite material, the inorganic material may have a particulate shape and be dispersed in a matrix formed of the organic material. Examples of organic materials include polyimide resin, polyethylene resin, polypropylene resin, polyamide resin, polyester resin, polyamide-imide resin, polysulfone resin, polycarbonate resin, liquid crystal polymer resin, polyvinylidene fluoride resin, and polytetrafluoroethylene resin. Examples of inorganic materials, particularly in composite materials, include oxides, carbides, nitrides, and inorganic salts. For example, oxides include silica, alumina, and zirconia; carbides and nitrides include silicon carbide and boron nitride; and inorganic salts include minerals such as wollastonite, kaolin, and mica. Among these, oxide-based materials such as oxides, silicates, and phosphates are preferred in terms of cost and insulation. Preferably, the inorganic material contains at least one selected from the group consisting of silicon (Si), phosphorus (P), boron (B), and calcium (Ca).

The coil insulator portion provided in the coil component 100 will be described in detail with reference to FIG. 6, which is an enlarged view of the region enclosed by the broken line on the X2 side in the X1-X2 direction in FIG. 5. FIG. 6 is an XZ cross-sectional view illustrating an example of the first insulator portion provided in the coil component according to an embodiment of the present invention.

In one example, the first insulator portion 90 exists independently as three portions, including a first insulator portion 901 located between the first inner-side turn 111 and the second inner-side turn 211, a first insulator portion 902 located between the first central turn 112 and the second central turn 212, and a first insulator portion 903 located between the first outer-side turn 113 and the second outer-side turn 213. Each of the first insulator portions 901, 902, and 903 has its end in the X1-X2 direction positioned further inward than the end of the adjacent turn in the X1-X2 direction, leaving a non-contact part at the turn end.

Specifically, the end on the X1 side in the X1-X2 direction of the first insulator portion 901 is positioned further inward (toward the X2 side) than the end on the X1 side of the first inner-side turn 111. Therefore, the portion of the first inner-side turn 111 facing the second inner-side turn 211 (first facing portion 11F) has a non-contact part EP that does not contact the first insulator portion 901. Based on this non-contact part EP, as shown in FIG. 6, when viewed in the first direction (Z1-Z2 direction), the envelope of the inner edge of the first insulator portion 90 in contact with the first inner-side turn 111 located on the innermost circumference, incorporates the inner edge of the first spiral conductor portion 11. Similarly, the second inner-side turn 211 has a non-contact part EP on the X1 side of the X1-X2 direction in the portion (second facing portion 21F) of the second inner-side turn 211 that faces the first inner circumferential turn 111.

### (Second Insulator Portion)

The coil insulator portion includes a second insulator portion 80, and as shown in FIG. 6, the second insulator portion 80 is provided on at least partially the surface of the first coil conductor portion 201 and the surface of the second coil conductor portion 202.

In this embodiment, the second insulator portion 80 is thermoplastic and includes a thermoplastic resin containing a parylene-based polymer. Other examples of thermoplastic resins include polyethylene, polypropylene, polyamide, polyester, polyamide-imide, polyimide, polysulfone, polycarbonate, liquid crystal polymer, polyvinylidene fluoride, and polytetrafluoroethylene. The second insulator portion 80 may also contain inorganic insulating particles in addition to the thermoplastic resin.

The second insulator portion 80 preferably has excellent insulating properties, specifically a volume resistivity of 1.0×10¹⁴ Ω·cm or more as measured by ASTM D257. More preferably, the volume resistivity is 1.0×10¹⁵ Ω·cm or more, and even more preferably 1.0×10¹⁶ Ω·cm or more. The upper limit of the volume resistivity is not particularly limited and may be 1.0×10²⁰ Ω·cm or less. The second insulator portion 80 preferably has excellent dielectric properties, specifically a relative permittivity at 60 Hz of 4.0 or less as measured by ASTM D150. More preferably, the relative permittivity is 3.5 or less, and even more preferably 3.0 or less. The lower limit of the relative permittivity is not particularly limited and may be 1.0 or more. Measurement of volume resistivity and relative permittivity uses a material equivalent to the second insulator portion 80 prepared to the required dimensions, similar to the method for the first insulator portion 90.

The second insulator portion 80 has a portion in contact with the opposite side of the first spiral conductor portion 11 from the side facing the second spiral conductor portion 21, namely the first opposite portion 11FA. In FIG. 6, the end parts of the first inner-side turn 111, the first central turn 112, and the first outer-side turn 113 on the Z1 side in the Z1-Z2 direction constitute the first opposite portion 11FA, and the second insulator portion 80 is provided on this portion.

The second insulator portion 80 also has a portion in contact with the second opposite portion 21FA of the second spiral conductor portion 21, which is opposite to the first spiral conductor portion 11. In FIG. 6, the end parts of the second inner-side turn 211, the second central turn 212, and the second outer-side turn 213 on the Z2 side in the Z1-Z2 direction constitute the second opposite portion 21FA, and the second insulator portion 80 contacts this portion.

The second insulator portion 80 has a portion in contact with a side portion of the first spiral conductor portion 11 along the spiral direction. If the first inner peripheral turn 111 is used to specifically describe the side portion, in the first inner-side turn 111, there are a side portion facing the inner side (X1 side in X1-X2 direction) and a side portion facing the outer side (X2 side in X1-X2 direction) and opposing the first central turn 112. The second insulator portion 80 has a portion in contact with these side portions. The end part of the first connecting conductor portion 15 on the outer side (X2 side in X1-X2 direction) is not covered by the second insulator portion 80 so as to form the second exposed part ES12, which can be electrically connected to another member (first external electrode 41, second external electrode 42). In a similar way, the end parts of the first connecting conductor portion 15 on both sides in the first direction (Z1-Z2 direction) may form the first exposed part ES11.

The second insulator portion 80 also has portions in contact with a side portion of the second spiral conductor portion 21 along the spiral direction. If the second inner peripheral turn 211 is used to specifically describe the side portion, in the second inner-side turn 211, there are a side portion facing the inner side (X1 side in X1-X2 direction) and a side portion facing the outer side (X2 side in X1-X2 direction) and opposing the first central turn 112. The second insulator portion 80 has a portion in contact with these side portions. The end part of the second connecting conductor portion 25 on the outer side (X1 side in X1-X2 direction) is not covered by the second insulator portion 80 so as to form the fourth exposed part ES22, which can be electrically connected to another member (third external electrode 43, fourth external electrode 44). In a similar way, the end parts of the first connecting conductor portion 15 on both sides in the first direction (Z1-Z2 direction) may form the third exposed part ES21.

From the perspective of stably providing the second insulator portion 80 on the side portions of the turns, the average gap width between two adjacent turns arranged alongside in a direction intersecting the first direction (XY in-plane direction) is preferably 0.025 times or more and 0.25 times or less the average width of the turns in the arrangement direction.

In the second insulating section 80, the thickness of the portion in contact with the first opposing portion 11FA (the opposing portion of the first spiral conductor section 11 relative to the second spiral conductor section 21), the thickness of the portion in contact with the second opposing portion 21FA (the opposing portion of the second spiral conductor section 21 relative to the first spiral conductor section 11), the thickness of the portion in contact with the side portion of the first spiral conductor portion 11, and the thickness of the portion in contact with the side portion of the second spiral conductor portion 21, may preferably be 0.2 μm or more and 10 μm or less from the perspective of good insulating properties of the second insulating portion 80. More preferably, the average thickness is 1.0 μm or more for more stable insulation.

Here, the first opposing portion 11F and the second opposing portion 21F have a non-contact part EP that does not contact the first insulating portion 90. In this non-contact part EP, the first opposing portion 11F and the second opposing portion 21F may contact the second insulating portion 80, but this is not limited thereto. For example, as a modification of the present invention, the first insulating portion 90 may not necessarily have a non-contact part EP. Additionally, the first insulating portion 90 may be positioned continuously (without interruption between adjacent turns as viewed from the first direction) between the first coil conductor portion 201 and the second coil conductor portion 202. Furthermore, the second insulating portion 80 may be arranged to fill the gap between adjacent turns (e.g., the first inner-side turn 111 and the first central turn 112).

### (Magnetic Powder and Others)

The magnetic powder may be a metallic magnetic powder formed of a metal material, and in this case, its crystallographic structure is not particularly limited. The structure may include a crystalline phase or an amorphous phase. Here, a crystalline material is defined as a material formed of a crystalline phase, an amorphous material as a material formed of an amorphous phase, and a composite material as a material formed of both a crystalline phase and an amorphous phase. If the diffraction spectrum obtained by a general X-ray diffraction method includes sharp diffraction peaks that identify the type of crystalline phase, the material contains a crystalline phase. If the diffraction spectrum obtained by a general X-ray diffraction method includes broad peaks indicating an amorphous phase, the material contains an amorphous phase. If the DSC curve obtained by differential thermal analysis includes a peak indicating crystallization, that is, heat generation accompanying a phase change from an amorphous phase to a crystalline phase, the material also contains an amorphous phase.

The material system of the magnetic powder is not particularly limited. Specific examples of crystalline materials include Fe—Si—Cr alloys, Fe—Ni alloys, Fe—Co alloys, Fe—V alloys, Fe—Al alloys, Fe—Si alloys, Fe—Si—Al alloys, pure iron, and ferrite. Carbonyl iron powder is preferred as the powder of pure iron. Specific examples of amorphous materials include Fe—Si—B alloys, Fe—P—C alloys, and Co—Fe—Si—B alloys. Specific examples of composite materials include Fe—Zr alloys, Fe—Zr—B alloys, Fe—Si—B—Nb—Cu alloys, and Fe—Si—B—P—Cu alloys. When the magnetic powder is a metal powder containing Fe (metallic magnetic powder), the synergistic effect of improving magnetic properties is particularly significant.

The chemical composition of the magnetic powder is not particularly limited. For example, an Fe—Si—Cr alloy may contain 1.0 to 10.0 mass % of Si, 1.0 to 10.0 mass % of Cr, and the balance consisting of Fe and impurities. An Fe—Ni alloy may contain 1.0 to 99.0 mass % of Ni and the balance consisting of Fe and impurities. Furthermore, an Fe—P—C alloy may contain 1.0 to 13.0 atomic % of P, 1.0 to 13.0 atomic % of C, and the balance consisting of Fe and impurities. The Fe—P—C alloy may optionally contain one or more elements selected from the group consisting of Ni, Sn, Cr, B, and Si. In this case, for example, the amount of Ni may be 0 to 10.0 atomic %, Sn may be 0 to 3.0 atomic %, Cr may be 0 to 6.0 atomic %, B may be 0 to 9.0 atomic %, and Si may be 0 to 7.0 atomic %. The amount of Fe is preferably 65 atomic % or more. Furthermore, an Fe—Si—B—Nb—Cu alloy may contain 1.0 to 16.0 atomic % of Si, 1.0 to 15.0 atomic % of B, 0.50 to 5.0 atomic % of Nb, 0.50 to 5.0 atomic % of Cu, and the balance consisting of Fe and impurities. In this case, the amount of Fe is preferably 65 atomic % or more.

The shape of the magnetic powder is not particularly limited. The magnetic powder may be spherical, elliptical, flaky, or irregular in shape. The manufacturing method for obtaining these shapes is also not particularly limited.

The particle size distribution of the magnetic powder is not particularly limited. The particle size distribution of the magnetic powder can be obtained, for example, by analyzing an image (secondary electron image) captured by scanning electron microscopy of a cut surface of the main body portion 30. For example, the average circle-equivalent diameter of the magnetic powder may be 0.50 to 50.0 μm. The distribution of circle-equivalent diameters may include multiple peaks.

The magnetic powder may be subjected to surface insulation treatment. When the magnetic powder is subjected to surface insulation treatment, the insulation resistance of the main body portion 30 is improved. The type of surface insulation treatment applied to the magnetic powder is not particularly limited. Examples include phosphate treatment, phosphate salt treatment, and oxidation treatment. The magnetic powder may have an insulating coating on the surface of the magnetic particles. The insulating coating may contain at least one selected from the group consisting of Si, P, and B, and oxygen (O).

The magnetic powder may be a mixed material in which multiple powder materials are mixed. The magnetic powder is preferably a ferromagnetic material and more preferably a soft magnetic material.

The main body portion 30 may further contain optional sub-materials. The optional sub-materials include, for example, a binder material or a modifier. The binder material binds particles such as magnetic powder contained in the main body portion 30. The binder material is preferably an insulating material to impart insulation resistance to the main body portion 30.

The binder material may be an organic material or an inorganic material. The organic material may be a resin material. Examples of resin materials include acrylic resin, silicone resin, epoxy resin, phenolic resin, urea resin, melamine resin, and polyester resin. The inorganic material may be a glass-based material such as water glass. The binder material may be a product of a reaction such as thermal decomposition or a mixture of multiple materials.

The modifier may improve the fluidity of the powder or adjust the curing speed of the binder material. The modifier may be a glass-based material.

The dimensions of the main body portion 30 are not particularly limited. For example, the maximal dimension of the main body portion 30 may be 3.2 mm or less.

### (Outer Cover)

An insulating outer cover 50 and 60 are provided as surface insulating portions on the upper surface (the surface on the Z1 side in the Z1-Z2 direction) and the side surfaces extending in the Y1-Y2 direction of the main body portion 30, respectively. An insulating outer cover may also be provided on the portion of the bottom surface (the surface on the Z2 side in the Z1-Z2 direction) of the main body 30 where the first external electrode 41 and the third external electrode 43 are not provided. Furthermore, the coil component 100 may not necessarily include the outer cover 50, 60. The outer cover 50, 60 may be formed at any position on the surface of main body portion 30 according to the required objectives. The outer cover 50, 60 may contain metallic magnetic powder included in the main body portion 30. In this case, it may be preferable that the area occupied by the metallic magnetic powder in the cross section of the outer cover 50, 60 is 50% or less of the area occupied by the metallic magnetic powder in the cross section of the main body portion 30.

### (Manufacturing Method)

The method for manufacturing the coil component 100 according to this embodiment is not particularly limited. One non-limiting example of the manufacturing method includes forming the first conductor portions 11A and 15A by electroplating (electrolytic plating).

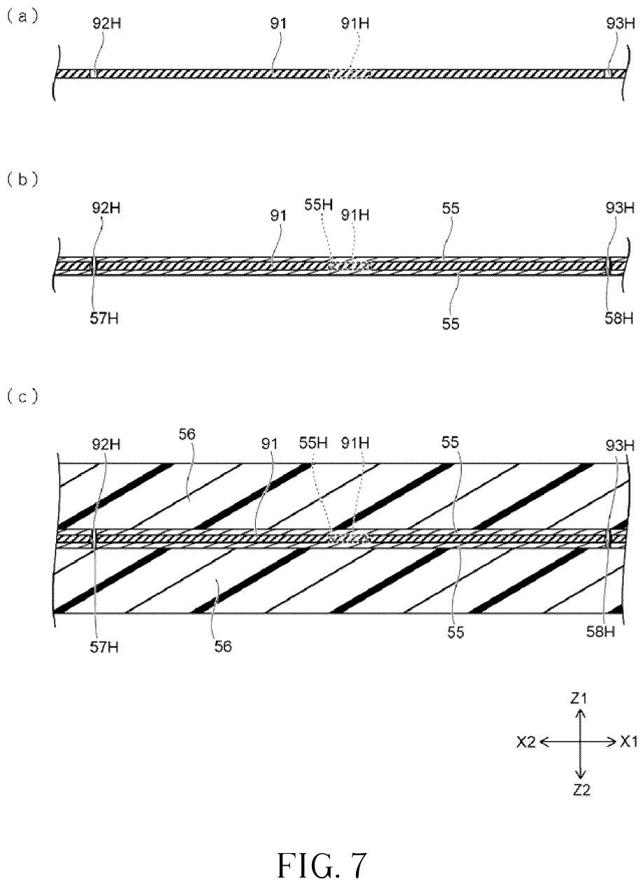

FIGS. 7 to 18 are explanatory diagrams (Parts 1 to 12) of an example of a manufacturing method for the coil component according to an embodiment of the present invention. The manufacturing method for the coil component 100 according to this embodiment includes forming the coil member 10 through a pattern forming step, a first plating step, and a second plating step, and preferably further includes a peeling step, a removal step, and a covering step.

### (a) Preparation of Sheet Substrate

First, as shown in FIG. 7(a), a sheet substrate 91 having substrate through holes (first substrate through hole 91H and second substrate through holes 92H and 93H), which are provided at positions corresponding to the via member VP, the first end via conductor portion VE1, and the second end via conductor portion VE2, is prepared. The sheet substrate 91 is not limited in material as long as it has mechanical properties sufficient to function as a support when forming the first spiral conductor portion 11 and the second spiral conductor portion 21. Preferably, the sheet substrate 91 has suitable insulating properties required as a raw material for the first insulator portion 90, and when a removal step is performed, it preferably has suitable removal characteristics at least in part.

The thickness of the sheet substrate 91 is set to appropriately function as a support when forming the first spiral conductor portion 11 and the second spiral conductor portion 21, and to consider the insulating properties of the first insulator portion 90 derived from the sheet substrate 91 and the removal characteristics of the sheet substrate 91 as necessary. As a non-limiting example, the thickness of the sheet substrate 91 may be 0.4 μm or more and 20 μm or less. The thickness may be 1.0 μm or more, and more preferably 5.0 μm or more. To further reduce the size of the coil component 100, the thickness of the sheet substrate 91 may be 14.0 μm or less.

Examples of materials constituting the sheet substrate 91 include organic materials, inorganic materials, and composite materials thereof. Specific examples of organic materials include polyimide resin, thermoplastic resins such as polyethylene resin, thermosetting resins such as epoxy resin and phenolic resin, and cellulose. Specific examples of inorganic materials include glass, oxide-based materials such as alumina, metal materials such as aluminum and magnesium, and inorganic salt-based materials such as calcium carbonate. Specific examples of composite materials include structures in which inorganic powder is dispersed in an organic material matrix.

### (b) Formation of Conductive Layer

In the pattern forming step, a pattern of the conductive layer 11C corresponding to the first conductor portion 11A (first partial pattern 11CP) is formed on one surface of the prepared sheet substrate 91 (the surface on Z1 side in Z1-Z2 direction), and a pattern of the conductive layer 21C corresponding to the first conductor portion 21A (fourth partial pattern 21CP) is formed on the other surface of the sheet substrate 91 (the surface on Z2 side in Z1-Z2 direction).

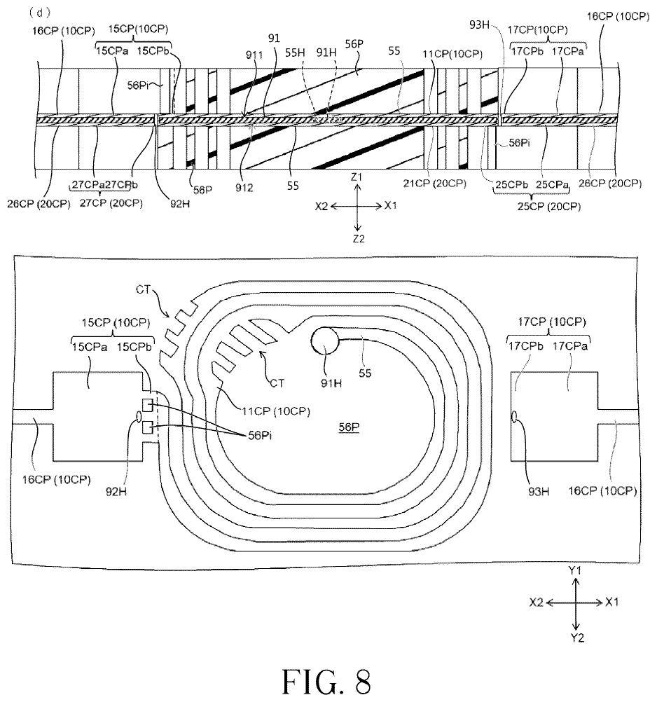

The specific method for forming the first partial pattern 11CP and the fourth partial pattern 21CP is not particularly limited. For example, the method shown in FIG. 7(b) to FIG. 8 may be used. First, as shown in FIG. 7(b), a conductive layer 55 made of the same material as the conductive layers 11C and 21C is formed on both surfaces of the sheet substrate 91 (both surfaces in Z1-Z2 direction). The method for forming the conductive layer 55 is not particularly limited. The conductive layer 55 may be formed by a dry process such as sputtering or by a wet process such as electroless plating. From the perspective of reducing the thickness of the conductive layer 55, it is preferable that the conductive layer 55 is formed by sputtering.

In this embodiment, as shown in FIG. 7(b), inner conductive layers 55H, 57H, and 58H are also formed on the inner surfaces of the first substrate through hole 91H and the second substrate through holes 92H and 93H. Alternatively, a member such as a copper-clad laminate having the conductive layer 55 provided in advance on both surfaces of the sheet substrate 91 may be prepared, and the first substrate through hole 91H and the second substrate through holes 92H and 93H may be provided therein. In this case, the inner surfaces of the first substrate through hole 91H and the second substrate through holes 92H and 93H may expose the material of the sheet substrate 91, or a process for providing inner conductive layers 55H, 57H, and 58H may be performed separately.

### (c) Formation of Insulating Layer

Next, as shown in FIG. 7(c), insulating layers 56 made of a patternable material such as dry film resist are laminated on each of the conductive layer 55 provided on both surfaces of the sheet substrate 91. The thickness of the insulating layer 56 is formed to be greater than the thickness of the first conductor portion 11A and greater than the thickness of the first conductor portion 21A, thereby improving the shape controllability of the first conductor portion 11A and the first conductor portion 21A.

### (d) Formation of Conductive Layer Pattern

Subsequently, as shown in FIG. 8, an exposure and development process is performed on the insulating layers 56 on both sides in the Z1-Z2 direction to remove partially the insulating layers 56 and form negative patterns 56P, thereby forming the first conductive pattern 10CP, which is formed from a pattern of the conductive layer 55, on a first substrate surface 911, which is a surface on one side of the sheet substrate 91 (Z1 side in Z1-Z2 direction), and forming the second conductive pattern 20CP, which is formed from a pattern of the conductive layer 55, on a second substrate surface 912, which is a surface on the other side of the sheet substrate 91 (Z2 side in Z1-Z2 direction).

The first conductive pattern 10CP formed on the first substrate surface 911 includes a first partial pattern 11CP, a second partial pattern 15CP, and a third partial pattern 16CP. The first partial pattern 11CP has a spiral shape corresponding to the shape of the first conductor portion 11A of the first spiral conductor portion 11. The second partial pattern 15CP includes a pattern 15CPb of the conductive layer 55 corresponding to the first conductor portion 152bA included in the first inner base portion 152b of the first connecting conductor portion 15. The third partial pattern 16CP corresponds to a first conductor portion 16A of a first connecting member 16 described later.

The second partial pattern 15CP is continuous with the pattern 15CPb of the conductive layer 55, and includes a large opening pattern 15CPa. A second partial pattern 17CP, distinct from the second partial pattern 15CP provided on the first substrate surface 911, is formed continuously with a pattern 17CPb of the conductive layer 55 corresponding to the first conductor portion 25A of the second connection conductor portion 25 (specifically, second upper protrusion 251b), and includes a large opening pattern 17PAb. By including large aperture patterns 15CPa and 17CPa, the second partial patterns 15CP and 17CP each have a circle equivalent diameter of at least 1.5 times the minimal turn width of the spiral shape in the first partial pattern 11CP. In one example, the second partial patterns 15CP and 17CP each have a shape where the ratio of the major axis to the minor axis in an equivalent ellipse is 3 or less. This equivalent elliptical shape may be circular, with the major and minor axes being equal in length.

The boundary between the first partial pattern 11CP and the second partial pattern 15CP continuous on the first substrate surface 911 is the boundary between the first spiral conductor portion 11 and the first connecting conductor portion 15, that is, the outer end part 13. The boundaries between the second partial pattern 15CP and the third partial pattern 16CP, and between the second partial pattern 17CP and the third partial pattern 16CP, which are continuous on the first substrate surface 911, form the boundaries between the regions where the second partial patterns 15CP and 17CP have the aforementioned shape characteristics, respectively, and their respective remaining portions. The third partial pattern 16CP has an elongated shape like a wire pattern as described later, and its width may be equal to or greater than the turn width of the first partial pattern 11CP.

The fifth partial pattern 25CP is continuous with the pattern 25CPb of the conductive layer 55 and includes a large opening pattern 25CPa. A fifth partial pattern 27CP, which is distinct from the fifth partial pattern 25CP provided on the second substrate surface 912, is continuous with a pattern 27CPb of the conductive layer 55 corresponding to the first conductor portion 15A of the first connection conductor portion 15 (specifically, the first lower protrusion 151b), and includes a large opening pattern 27CPa. By including the large opening patterns 25CP and 27CP, the fifth partial patterns 25CP and 27CP each have a circular equivalent diameter of at least 1.5 times the minimal turn width of the spiral shape in the fourth partial pattern 21CP. In one example, the fifth partial patterns 25CP and 27CP each have a shape where the ratio of the major axis to the minor axis in an equivalent ellipse is 3 or less. The equivalent elliptical shape may also be a circular shape in which the lengths of the major axis and the minor axis are equal.

The boundary between the fourth partial pattern 21CP and the fifth partial pattern 25CP continuous on the second substrate surface 912 is the boundary between the second spiral conductor portion 21 and the second connecting conductor portion 25, that is, the outer end part 23. The boundaries between the fifth partial pattern 25CP and the sixth partial pattern 26CP, and between the second partial pattern 17CP and the third partial pattern 16CP, which are continuous on the second substrate surface 912, form the boundaries between the regions where the second partial patterns 15CP and 17CP have the aforementioned shape characteristics, respectively, and their respective remaining portions. The shape of the sixth partial pattern 26CP may be the same as that of the third partial pattern 16CP.

As shown in the XY plan view of FIG. 8, the first partial pattern 11CP has a comb-tooth shape CT in a region corresponding to the turn widening portion 11W of the first spiral conductor portion 11, corresponding to the shape of the first conductor portion 11A.

### (e) Formation of First Conductor Portion

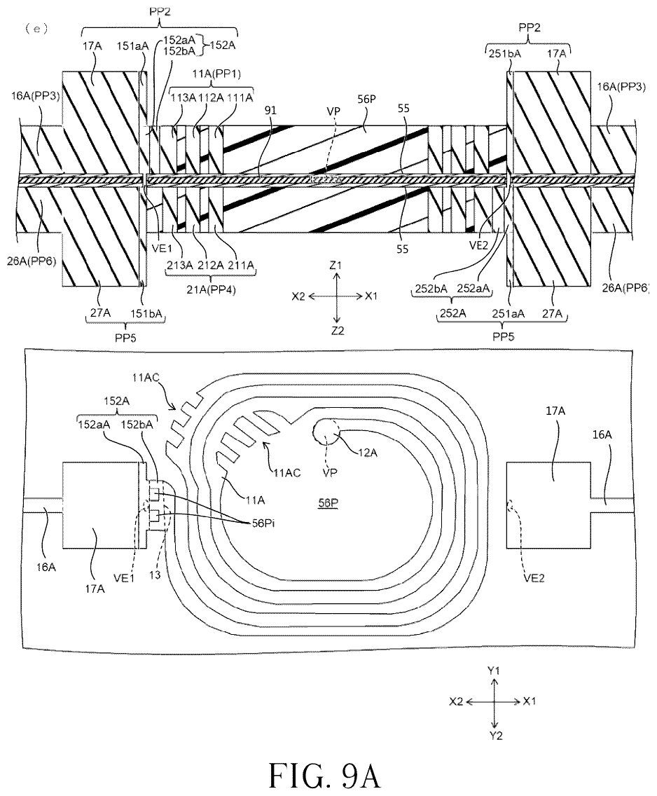

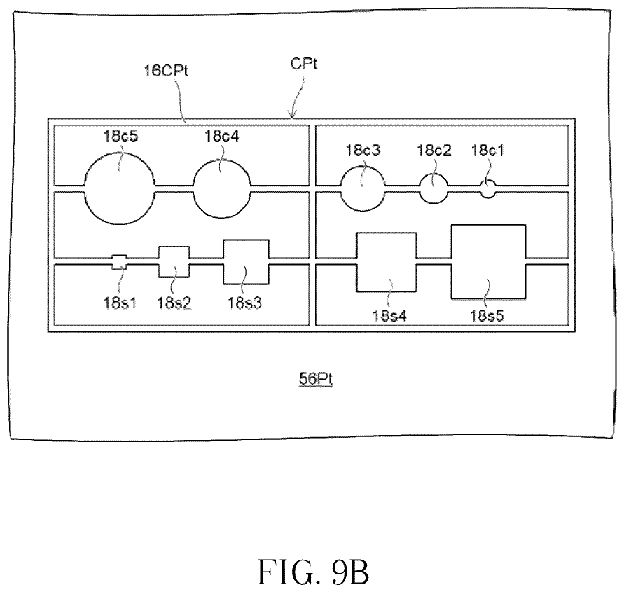

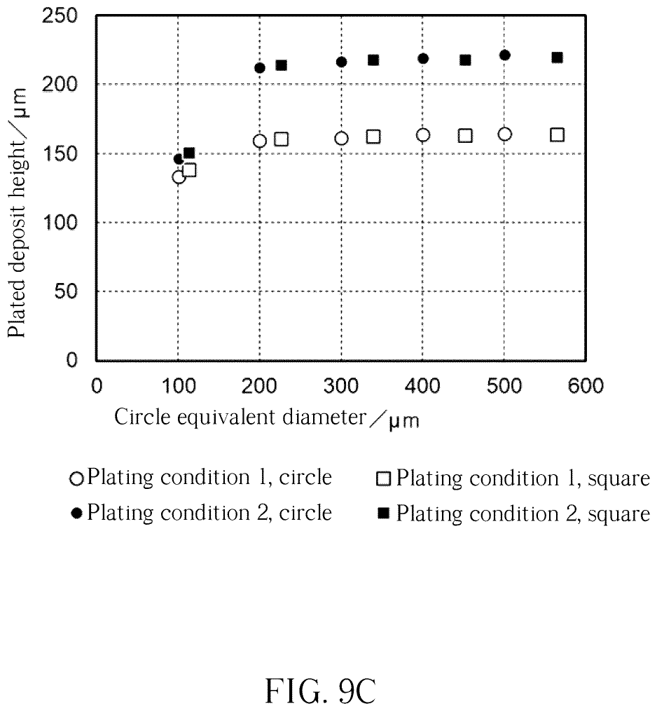

After the first conductive pattern 10CP and the second conductive pattern 20CP are formed, as shown in FIG. 9A, a first plating step is performed. In the first plating step, electric current is applied to the conductive layer 55 provided on both surfaces of the sheet substrate 91 (first substrate surface 911 and second substrate surface 912), and by electroplating, a first conductor portion 11A (111A, 112A, 113A) formed of a first plated deposit is formed on the first partial pattern 11CP on the first substrate surface 911 as a first plated portion PP1; first conductor portions 152A (152aA, 152bA), 151aA, 251bA, and 17A formed of a first plated deposit are formed on the second partial patterns 15CP and 17CP as a second plated portion PP2; and a first conductor portion 16A formed of a first plated deposit is formed on the third partial pattern 16CP as a third plated portion PP3.

Similarly, on the side with the second substrate surface 912, the first conductor portion 21A (211A, 212A, 213A) is formed as the fourth plated portion PP4. On the fifth partial patterns 25CP and 27CP, the first conductor portion 252A (252aA, 252bA), 251aA, 151bA, and 27A, formed from the first plated deposit, are formed as the fifth plated portion PP5. On the sixth partial pattern 26CP, the first conductor portion 261A (261aA, 261bA), 262A, 263A, formed from the first plated deposit, are formed as the sixth plated portion PP6. 252aA, 251bA, 27A as the fifth plated portion PP5, and form a first conductor portion 26A made of the first plated deposit as the sixth plated portion PP6 on the sixth partial pattern 26CP.

Similarly, on the side of the second substrate surface 912, a first conductor portion 21A (211A, 212A, 213A) formed from the first plated deposit is formed on the fourth partial pattern 21CP as a fourth plated portion PP4. First conductor portions 252A (252aA, 252bA), 251aA, 151bA, and 27A formed from the first plated deposit are formed on the fifth partial patterns 25CP and 27CP as a fifth plated portion PP5. A first conductor portion 26A formed from the first plated deposit is formed on the sixth partial pattern 26CP as a sixth plated portion PP6.

In addition, the substrate through holes (first substrate through hole 91H and second substrate through holes 92H and 93H) are also filled with the first plated deposit, thereby forming the via member VP, the first end via conductor portion VE1, and the second end via conductor portion VE2. The first conductors 12A and 22A constituting the inner end parts 12 and 22 are formed of the first plated deposit deposited on both sides of the via member VP in the Z1-Z2 direction.

In the pattern forming step, since the negative patterns 56P formed from the insulating layers 56 are arranged around the periphery of the first conductive pattern 10CP and the second conductive pattern 20CP, in the first plating step, electroplating is performed using the negative patterns 56P as masking material, thereby forming a plurality of first conductor portions 11A (111A, 112A, 113A), 152A (152aA, 152bA), 151aA, 17A, and 16A continuously and integrally on the side with the first substrate surface 911, and forming a plurality of first conductor portions 251bA, 17A, and 16A continuously and integrally. Similarly, on the side with the second substrate surface 912, a plurality of first conductor portions 21A (211A, 212A, 213A), 252A (252aA, 252bA), 251aA, 27A, and 26A are continuously and integrally formed, and a plurality of first conductor portions 151bA, 27A, and 26A are continuously and integrally formed. Furthermore, in the first plating step, the via member VP, the first end via conductor portion VE1, and the second end via conductor portion VE2 are formed to fill the first substrate through hole 91H and the second substrate through holes 92H and 93H. Accordingly, in the first plating step, the conductive members constituting the first spiral conductor portion 11 and the conductive members constituting the second spiral conductor portion 21 are integrally formed.

As shown in the XY plan view of FIG. 9A, the first conductor portion 11A has an uneven portion 11AC with a shape different from other portions corresponding to the comb-tooth shape CT of the first partial pattern 11CP. The first conductor portion 152bA has three portions shorter in the Y1-Y2 direction than the outer end part 13 due to the pillar-shaped negative pattern 56Pi.

The first plated deposit formed by electroplating is not particularly limited as long as it has suitable conductivity. As described above, a material containing Cu, such as copper or a copper alloy, is a non-limiting example.

Here, in electroplating performed from the negative patterns 56P provided around the periphery of the pattern of the conductive layer 55 pattern, the exposed area of the pattern of the conductive layer 55 may affect the plating process. In this plating process, the first plated deposit is formed on the surface of the conductive layer 55 from metal ions contained in the plating solution. When the first plated deposit is formed, the concentration of metal ions near the surface of the conductive layer 55 decreases, creating a concentration gradient of metal ions between the vicinity of the surface of the conductive layer 55 and the bulk of the plating solution. Metal ions are supplied to the vicinity of the surface of the conductive layer 55 by diffusion driven by this concentration gradient, and electrons are rapidly supplied to the vicinity of the surface of the conductive layer 55 by current flow. Formation of the first plated deposit thus continues. In addition to diffusion, the flow of the plating solution also supplies metal ions to the vicinity of the surface of the conductive layer 55. In regions with a narrow exposed area, the space above the conductive layer 55 sandwiched by the negative patterns 56P is narrow, and the negative patterns 56P may obstruct the flow of the plating solution or restrict the direction of diffusion of metal ions contained in the plating solution. Therefore, in regions with a narrow exposed area, the supply of metal ions to the surface of the conductive layer 55 tends to stagnate, and the formation rate of the first plated deposit tends to be smaller than in regions with a wide exposed area.

As described above, the second partial pattern 17CP and the fifth partial pattern 27CP have larger openings than other partial patterns, and the exposed areas are large. Therefore, the first plated deposits (first conductor portion 17A, 27A) formed on the second partial pattern 17CP and the fifth partial pattern 27CP tend to have greater plated deposit heights than other portions. To experimentally confirm this tendency, a test pattern CPt shown in FIG. 9B is prepared.

On one surface of a test sheet substrate 91, a conductive layer 55 is formed, and a test negative pattern 56Pt is formed thereon. The test negative pattern 56Pt formed a test conductive layer pattern CPt on the sheet substrate 91. The test pattern CPt, when viewed in the normal direction of the sheet substrate 91 surface, includes circular opening patterns 18cl to 18c5 with diameters of 100 μm, 200 μm, 300 μm, 400 μm, and 500 μm, respectively, and square opening patterns 18s1 to 18s5 with side lengths of 100 μm, 200 μm, 300 μm, 400 μm, and 500 μm, respectively, and these opening patterns are connected to each other by a test connecting partial pattern 16CPt.

Two test patterns CPt are prepared, and copper plating is performed under plating conditions with different current densities and energizing times. As a result, the results shown in Table 1 and FIG. 9C are obtained. FIG. 9C is a graph showing the test results using the test pattern, in which the horizontal axis represents the circle-equivalent diameter of the opening pattern (unit: μm), and the vertical axis represents the height of the first plated deposit precipitated in the opening pattern (unit: μm).

TABLE 1

| Plating | | | | | | | |
|---|---|---|---|---|---|---|---|
| Condition | Shape | Unit: μm | | | | | |
| 1 | Circle | Circle | 100 | 200 | 300 | 400 | 500 |
| | | Equivalent | | | | | |
| | | Diameter | | | | | |
| | | Deposit | 133.1 | 159.7 | 161.5 | 164.1 | 164.4 |
| | | Height | | | | | |
| | Square | Circle | 113 | 226 | 339 | 451 | 564 |
| | | Equivalent | | | | | |
| | | Diameter | | | | | |
| | | Deposit | 138.4 | 160.7 | 162.4 | 163.1 | 163.8 |
| | | Height | | | | | |
| 2 | Circle | Circle | 100 | 200 | 300 | 400 | 500 |
| | | Equivalent | | | | | |
| | | Diameter | | | | | |
| | | Deposit | 146.2 | 212.7 | 216.7 | 219.0 | 221.5 |
| | | Height | | | | | |
| | Square | Circle | 113 | 226 | 339 | 451 | 564 |
| | | Equivalent | | | | | |
| | | Diameter | | | | | |
| | | Deposit | 150.9 | 214.3 | 218.1 | 218.3 | 219.9 |
| | | Height | | | | | |

As shown in Table 1 and FIG. 9C, under all plating conditions and for all opening shapes, the plated deposition height is greater for equivalent circular diameters of 200 μm or more than for equivalent circular diameters of 100 μm. Furthermore, the first plated deposit height became almost equal within the range of circle equivalent diameters from 200 μm to 600 μm, and it is confirmed that the height within this range can be adjusted by changing the plating conditions.

Based on the above verification experiment, it is confirmed that by setting the circle equivalent diameter of the second partial pattern 17CP and the fifth partial pattern 27CP to be 1.5 times or more, preferably twice or more, the width (minimal turn width) of the first partial pattern 11CP and the fourth partial pattern 21CP, the first conductor portions 17A and 27A can be formed higher than the first conductor portions 11A and 21A. Specifically, a height being 1.2 times or more is possible. The height can be adjusted by appropriately setting the plating conditions.

Based on the above consideration, by optimizing the plating conditions, the maximal length (deposit height) of the second plated portion PP2 in the first direction is set to be 1.2 times or more the maximal length (deposit height) of the first plated portion PP1 in the first direction. Similarly, the maximal length (deposit height) in the first direction of the fifth plated portion PP5 is set to be 1.2 times or more the maximal length (deposit height) of the fourth plated portion PP4 in the first direction. The second plated portion PP2 and the fifth plated portion PP5, which are thus made higher than other portions, may be used as wiring extending in the first direction (Z1-Z2 direction) toward the mounting surface side (Z2 side in the Z1-Z2 direction) within the main body portion 30, or may be used as support portions 17 in the compression direction during formation of the main body portion 30 by compression molding, as described later.

In addition, since a pillar-shaped negative pattern 56Pi is provided on the pattern 15CPb of the conductive layer 55, which is part of the second partial pattern 15CP corresponding to the first inner base portion 152b, the opening width is equivalent to that of the first partial pattern 11CP. Therefore, unlike the large opening pattern 15CPa of the conductive layer 55 in the second partial pattern 15CP, the plated deposit height of the first conductor portion 152bA formed on this pattern is equivalent to that of the first conductor portion 11A included in the first spiral conductor portion 11. Thus, by adjusting the opening width of the pattern of the conductive layer 55, the height of the plated deposit formed can be adjusted. For example, by omitting the pillar-shaped negative pattern 56Pi or reducing its size or number, the height of the plated deposit can be made higher than the height of the first conductor portion 11A included in the first spiral conductor portion 11. Furthermore, for example, by gradually changing the size of the pillar-shaped negative pattern 56Pi (specifically, reducing its length in Y1-Y2 direction as it moves away from the spiral conductor portion in X1-X2 direction), the height of the plated deposit can also be gradually varied.

### (f) Removal of Negative Pattern

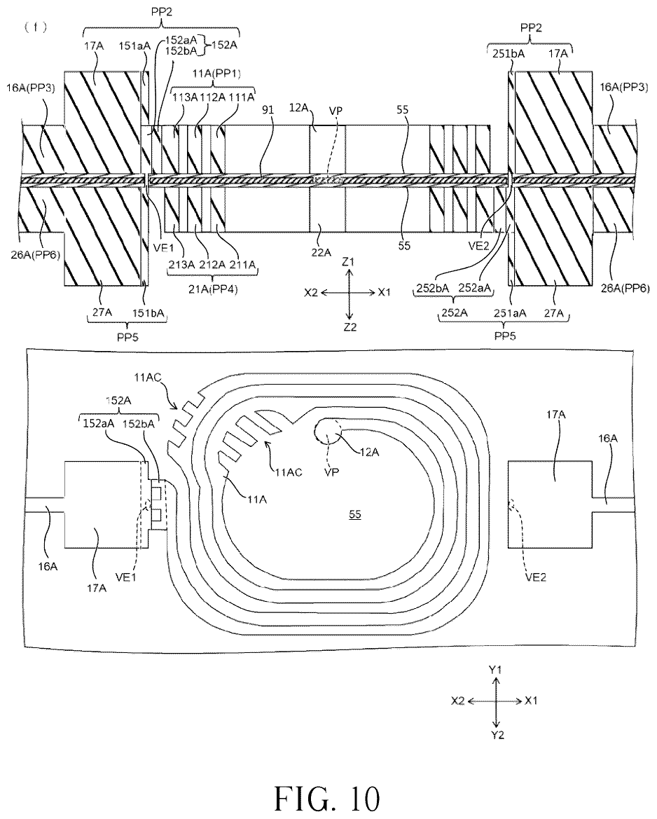

After the first plated portion PP1, the second plated portion PP2, the third plated portion PP3, the fourth plated portion PP4, the fifth plated portion PP5, and the sixth plated portion PP6 are formed on both surfaces of the sheet substrate 91, a peeling step is performed to remove the negative patterns 56P formed from the insulating layers 56. As a result, as shown in FIG. 10, a structure is obtained in which the first plated portion PP1, the second plated portion PP2, the third plated portion PP3, the fourth plated portion PP4, the fifth plated portion PP5, and the sixth plated portion PP6 are arranged on the conductive layer 55 provided on the sheet substrate 91. As described above, the first conductor portion 11A and the first conductor portion 21A are electrically connected by the via member VP. The first conductor portion 152aA, which is part of the second plated portion PP2, and the first conductor portion 151bA, which is part of the fifth plated portion PP5, are electrically connected by the first end via conductor portion VE1. The first conductor portion 252aA, which is part of the fifth plated portion PP5, and the first conductor portion 251bA, which is part of the second plated portion PP2, are electrically connected by the second end via conductor portion VE2.

### (g) Removal of Conductive Layer

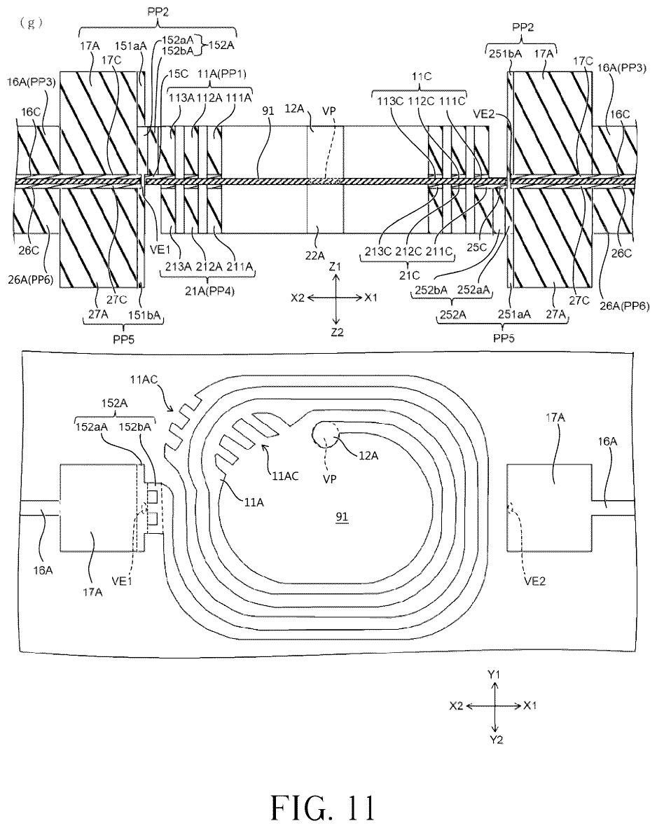

Subsequently, as part of the peeling step, portions of the conductive layer 55 on the sheet substrate 91, which are exposed in the first direction (Z1-Z2 direction), specifically the portions not covered by the first plated portion PP1, the second plated portion PP2, the third plated portion PP3, the fourth plated portion PP4, the fifth plated portion PP5, and the sixth plated portion PP6, are removed. As a result, as shown in FIG. 11, the conductive layer 55 remaining on the sheet substrate 91 become the conductive layers 11C, 15C, 21C, and 25C as components of the coil member 10, and the conductive layers 16C, 17C, 26C, and 27C provided to electrically connect to the coil member 10.

The method for removing the conductive layer 55 is not particularly limited. Any process capable of removing the material constituting the conductive layer 55 with minimal impact on the first plated portion PP1, the second plated portion PP2, the third plated portion PP3, the fourth plated portion PP4, the fifth plated portion PP5, and the sixth plated portion PP6 may be appropriately selected. For example, when the first plated portion PP1, the second plated portion PP2, the third plated portion PP3, the fourth plated portion PP4, the fifth plated portion PP5, and the sixth plated portion PP6 are formed of Cu, and the conductive layer 55 are formed of Ni, the etching characteristics thereof differ, so the portions of the conductive layer 55 not covered by the first plated portion PP1, the second plated portion PP2, the third plated portion PP3, the fourth plated portion PP4, the fifth plated portion PP5, and the sixth plated portion PP6 can be etched with high selectivity. When the material constituting the conductive layer 55 is the same as that of the first plated portion PP1, the second plated portion PP2, the third plated portion PP3, the fourth plated portion PP4, the fifth plated portion PP5, and the sixth plated portion PP6, then the first plated portion PP1, the second plated portion PP2, the third plated portion PP3, the fourth plated portion PP4, the fifth plated portion PP5, and the sixth plated portion PP6 will also be partially removed by the process for removing the material constituting the conductive layer 55, but the shape of the electroplated deposit formed in the first plating process may be designed to account for this removal.

### (h) Formation of Second Conductor Portion

By removing the conductive layer 55 as described above, the conductive members exposed on the sheet substrate 91 are substantially only the first plated portion PP1, the second plated portion PP2, the third plated portion PP3, the fourth plated portion PP4, the fifth plated portion PP5, and the sixth plated portion PP6. In this state, by performing a plating process as the second plating step, a plating layer formed of the second plated deposit is formed on the exposed surfaces of the first plated portion PP1, the second plated portion PP2, the third plated portion PP3, the fourth plated portion PP4, the fifth plated portion PP5, and the sixth plated portion PP6 as second conductor portions 11B, 15B, 16B, 17B, 21B, 25B, 26B, and 27B. The plating process in the second plating step may be an electroplating (electrolytic plating) process or an electroless plating process.

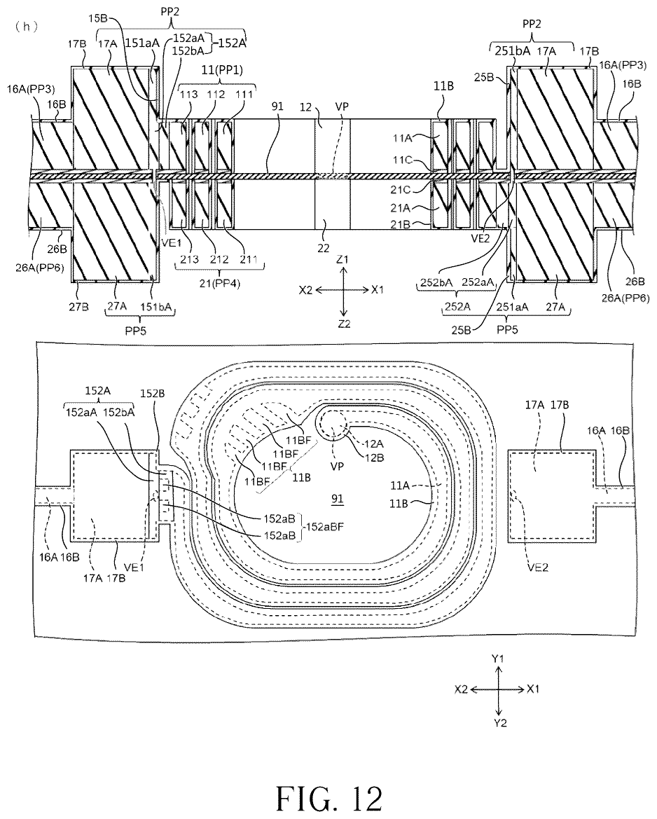

By performing the plating process, as shown in FIG. 12, the second conductor portions 11B, 21B, and 12B are provided around the first conductor portions 11A, 21A, and 12A. The gaps between the comb teeth of the first conductor portions 11A and 21A are filled by the second conductor portions 11B and 21B to form filling portions 11BF. In addition, the exposed portions based on the negative pattern 56Pi are filled by the second conductor portion 152aB to form a filling portion 152aBF, which becomes part of the first inner base portion 152b. Although not shown in FIG. 12, a second conductor is also provided around the first conductor 22A.

### (i) Removal of Sheet Substrate

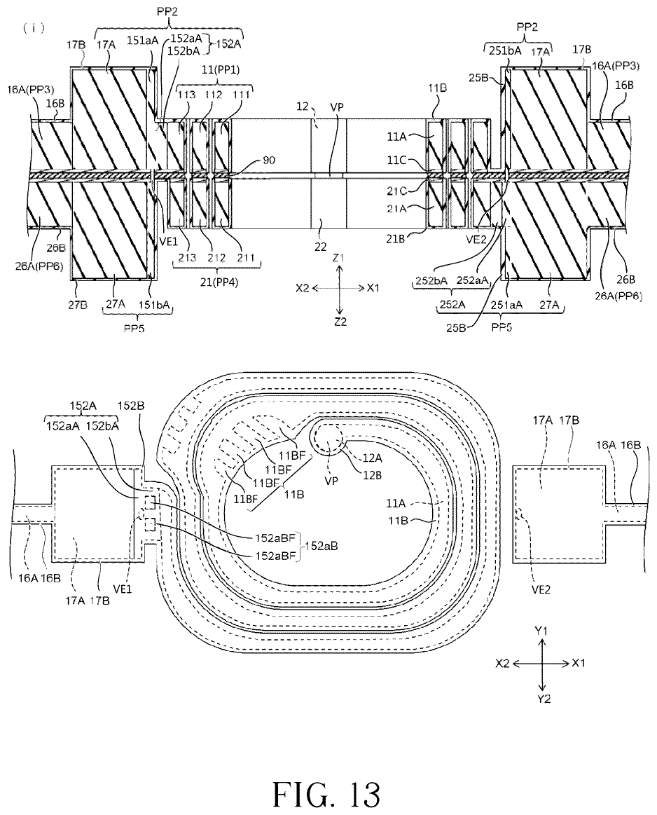

Subsequently, a sheet removal step is performed to remove the exposed portion of the sheet substrate 91 where no conductive member is provided. Specifically, as shown in FIG. 13, when viewed in the first direction (Z1-Z2 direction), the sheet substrate 91 is removed so as to include the region surrounded by the inner edge of the first spiral conductor portion 11 in the sheet substrate 91. As a result, the first insulator portion 90 is formed.

The specific removal process for the sheet substrate 91 is appropriately set according to the material constituting the sheet substrate 91. The removal process is broadly classified into a dry process such as plasma etching and a wet process such as wet etching. From the perspective of preventing the sheet substrate 91 from remaining in the region surrounded by the inner edge of the first spiral conductor portion 11, a wet etching process, which is an isotropic removal process, is preferable. From the perspective of improving the removal efficiency of the sheet substrate 91, a wet process may also be preferable. The removal process may leave part of the sheet substrate 91 unremoved. For example, when the sheet substrate 91 is formed of a composite material of organic and inorganic materials, only the organic material may be removed in the removal process.

### (j) Formation of Second Insulator Portion

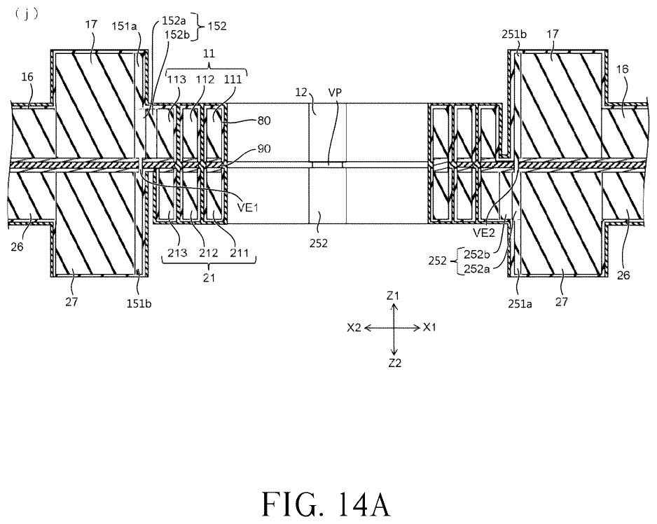

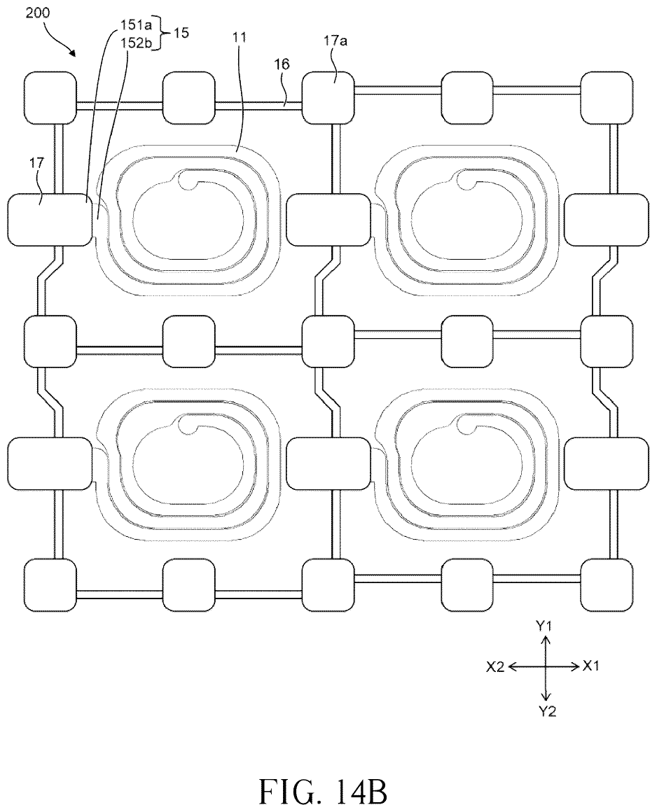

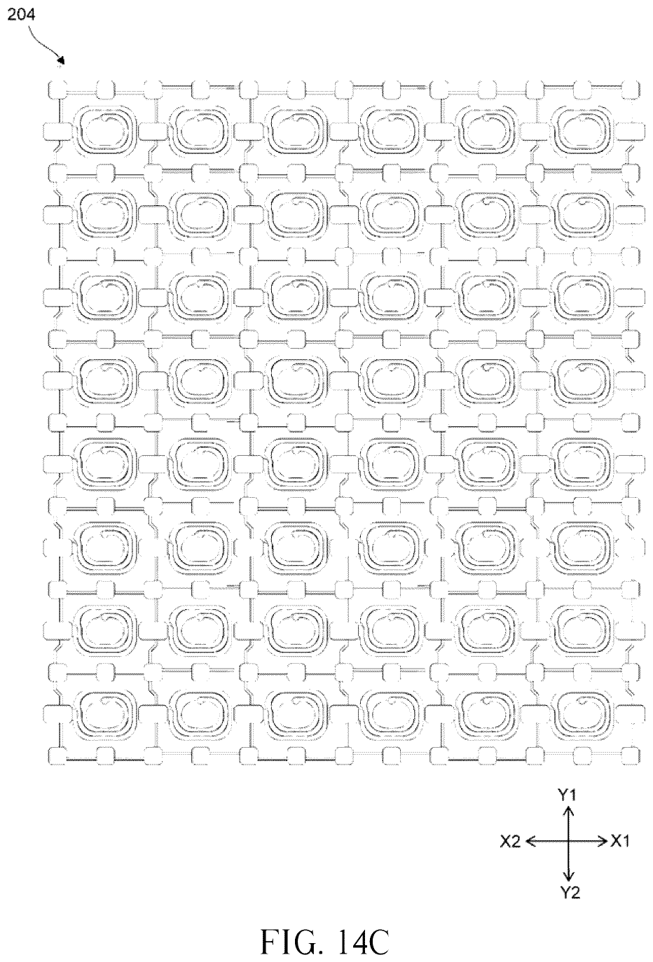

After the sheet substrate 91 is removed, a covering step is performed to form the second insulator portion 80 made of an insulating material so as to cover at least part of the exposed portions of the coil conductor portion 20 obtained through the first plating step and the second plating step. In FIG. 14A, the second insulator portion 80 is provided on surfaces other than the surfaces of the second conductor portions 15B, 25B, 17B, and 27B, which are provided on surfaces facing the Z1-Z2 direction of the first conductor portions 151aA, 151bA, 17A, 251aA, 251bA, and 27A with large plated deposit heights. The product of step (j) renders the configuration of the coil member 10 of the coil component 100. In other words, by performing up to step (j), all components of the coil member 10 can be formed.

The process for forming the second insulator portion 80 is appropriately set according to the material constituting the second insulator portion 80. For example, when the second insulator portion 80 is made of a parylene-based polymer, it is formed by a dry process (CVD). When the second insulator portion 80 contains a curable resin material such as epoxy resin, it can be formed by attaching a powder or liquid containing the material constituting the second insulator portion 80 to the exposed surface and then solidifying the attachment by heating or the like.

FIG. 14B is a diagram illustrating a coil array, and FIG. 14C is a diagram illustrating a coil array sheet. In FIG. 14B and FIG. 14C, for clarity, members provided on the second substrate surface 912 (such as the second spiral conductor portion 21) and the second insulator portion 80 are omitted. In the description up to FIG. 14A, the case of forming the components of the coil component 100 is taken as a specific example, but as shown in FIG. 14B, the first connecting conductor portion 15 and the support portion 17 may be provided in continuation of the first spiral conductor portion 11, forming a coil array 200 having a structure in which a plurality of members, each comprising the first spiral conductor portion 11, the first connection conductor portion 15, and the support portion 17, are arranged in the X1-X2 direction and the Y1-Y2 direction. In other words, by performing Step (j) and earlier steps, all components of coil section 10 can be formed.

In the case of the coil array 200, the first conductive pattern 10CP includes a plurality of the first partial patterns 11CP and second partial patterns 15CP and 17CP. The third partial pattern 16CP included in the first conductive pattern 10CP satisfies at least one of the following: (1) connecting two first partial patterns 11CP on the first substrate surface 911; (2) connecting two second partial patterns 15CP and 17CP on the first substrate surface 911; and (3) connecting one first partial pattern 11CP and one second partial pattern 17CP on the first substrate surface 911.

The second partial pattern 15CP is a pattern continuous with the first partial pattern 11CP on the first substrate surface 911. On the other hand, the second partial pattern 17CP is a pattern not continuous with the first partial pattern 11CP on the first substrate surface 911 but connected thereto via the third partial pattern 16CP on the first substrate surface 911. As described later, a coil chip 220 includes the first plated portion PP1 formed on the first partial pattern 11CP and the second plated portion PP2 (specifically the first conductor portion 251bA) formed on the second partial pattern 17CP (specifically the pattern 17CPb of the conductive layer 55).

Similarly, the second conductive pattern 20CP includes multiple fourth partial patterns 21CP and fifth partial patterns 25CP and 27CP. The sixth partial pattern 26CP included in the second conductive pattern 20CP satisfies at least one of the following: (1) connecting two fourth partial patterns 21CP on the second substrate surface 912; (2) connecting two fifth partial patterns 25CP and 27CP on the second substrate surface 912; and (3) connecting one fourth partial pattern 21CP and one fifth partial pattern 27CP on the second substrate surface 912.

The fifth partial pattern 25CP is a pattern continuous with the fourth partial pattern 21CP on the second substrate surface 912. On the other hand, the fifth partial pattern 27CP is a pattern not continuous with the fourth partial pattern 21CP on the second substrate surface 912 but connected thereto via the sixth partial pattern 26CP on the second substrate surface 912. As described later, the coil chip 220 includes the fourth plated portion PP4 formed on the fourth partial pattern 21CP and the fifth plated portion PP5 (specifically the first conductor portion 151bA) formed on the fifth partial pattern 27CP (specifically the pattern 27CPb of the conductive layer 55).

In FIG. 14B, a plurality of members formed from the first spiral conductor portion 11, the first connecting conductor portion 15, and the support portion 17 are connected by the first connecting member 16, and a connecting path formed by the first connecting member 16 is provided with a connecting path support portion 17a. Since the connecting path support portion 17a, like the support portion 17, has a relatively large area when viewed in the first direction, its plated deposit height is higher than that of the first connecting member 16. When the number of first spiral conductor portions 11 included in the coil array 200 is large, the overall shape becomes sheet-like as shown in FIG. 14C, forming a coil array sheet 204.

### (k) Formation of Main Body Portion

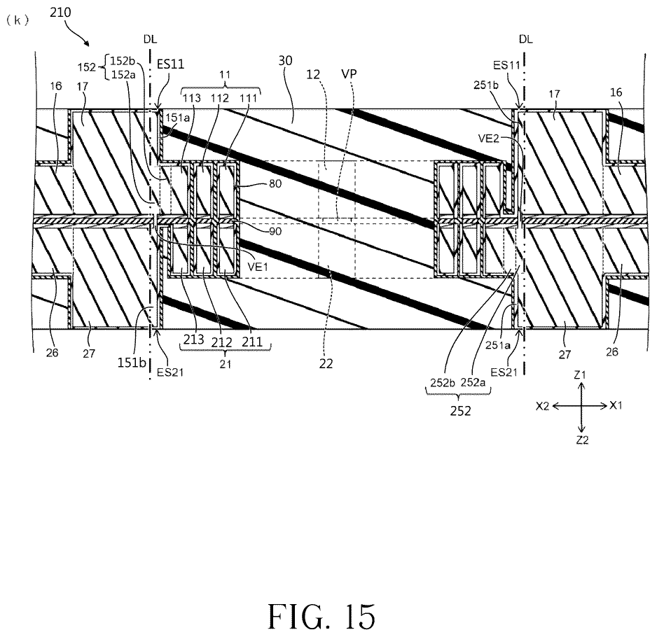

After the coil member 10 is formed through the above steps, the next step is to form the main body portion 30 by sealing the first spiral conductor portion 11 and the second spiral conductor portion 21 in the coil member 10 with a material containing magnetic powder so as to cover them from the first direction (Z1-Z2 direction), as shown in FIG. 15. The method for forming the main body portion 30 is not particularly limited, and a shape forming process is exemplified. In other words, Step (k) may be a shape forming step. Specific examples of the shape forming process include placing the product of step (j) in a mold and forming the main body portion 30 by compression molding of a material containing magnetic powder, or transfer molding a material containing magnetic powder or a member serving as a raw material for the material.

As described above, when the product of Step (j) is a coil array 200 or a coil array sheet 204, the product of Step (k) becomes a plate material 210 having a plate-like shape with the first direction (Z1-Z2 direction) as the thickness direction.

When the product of Step (j) is placed in a mold and compression molded to obtain the product of Step (k), it is preferable, from the perspective of improvement on molding quality (specifically, the uniformity of the thickness of the product of Step (k)), to improve the uniformity of the thickness (height in the first direction) of the spiral conductor portions (first spiral conductor portion 11 and second spiral conductor portion 21) in the coil member 10. In this regard, since the plated deposit heights of the first conductor portions 17A and 27A are formed higher than others in Step (e), it is preferable to use the portions including the first conductor portions 17A and 27A as the support portions 17 and 27. Specifically, if the surfaces facing the Z1-Z2 direction of the support portions 17 and 27 are arranged to contact the inner surface of the mold, it becomes easy to make the height in the Z1-Z2 direction of the shape-formed main body portion 30 uniform.

Moreover, since the product of Step (j) is molded in a state where the support portions 17 and 27 are in contact with the mold, the possibility of the product of Step (j) moving within the mold in the plane direction (XY in-plane direction) perpendicular to the first direction during the shape forming process can be reduced. Furthermore, since the surfaces facing the Z1-Z2 direction of the first protrusion portion 151 and the second protrusion portion 251 connected to the surfaces facing the Z1-Z2 direction of the support portions 17 and 27 are also in contact with the mold, these surfaces are not covered by the material constituting the main body portion 30 during molding. Thus, the first exposed part ES11 and the third exposed part ES21 can be formed in the product of Step (k) (plate material 210).

Mechanical processing such as polishing or surface treatment such as etching may be performed on the surfaces of the plate material 210, where the first exposed part ES11 and the third exposed part ES21 should be formed, specifically, on the surfaces of the plate material 210 in the Z1-Z2 direction, where the first protrusion portion 151 (first upper protrusion portion 151a and first lower protrusion portion 151b) and the second protrusion portion 251 (second upper protrusion portion 251b and second lower protrusion portion 251a) are located. This makes it possible to form the first exposed part ES11 and the third exposed part ES21 relatively stably. In this case, in Step (j), the second insulator portion 80 can be formed on the entire surface of the product of Step (i). As a result of the surface treatment, local recesses may be formed on the surface of the plate material 210 or the coil component 100, and the first exposed part ES11 and the third exposed part ES21 may be located on the bottom surfaces or inner surfaces of the recesses. As described later, when external electrodes (first external electrode 41 and third external electrode 43) are formed on the third exposed part ES21 and an outer cover 50 is formed on the first exposed part ES11, the above surface treatment may be performed only on the third exposed part ES21.

### (l) Cutting

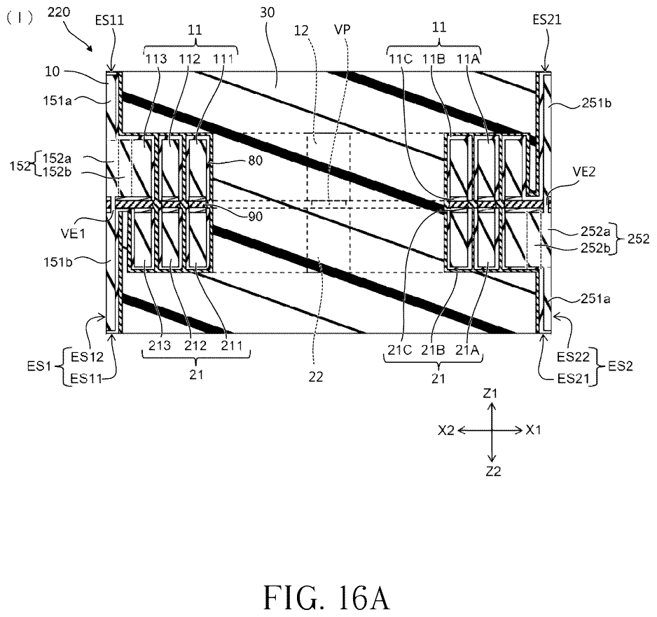

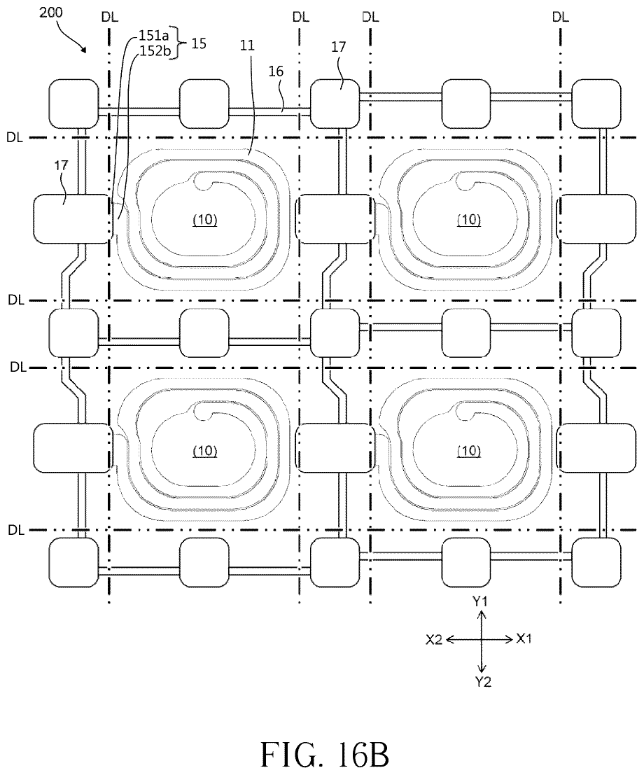

Next, the product of Step (k) (plate material 210) is cut in a manner that the first direction (Z1-Z2 direction) is parallel to the cut surface, and a cutting step is performed to separate a coil chip 220 including one coil member 10 as a first member, as shown in FIG. 16A. Specifically, two cut surfaces parallel to the XZ plane and two cut surfaces parallel to the YZ plane are formed. FIG. 15 shows a cutting line DL based on a cut surface parallel to the YZ plane. By cutting along this cutting line DL, the first connecting conductor portion 15 and the second connecting conductor portion 25 are separated from the support portion 17, and the second exposed part ES12 and the fourth exposed part ES22 are formed.

In the case of the coil array 200, as shown in FIG. 16B, it is preferable that the individual coil portions 10 in the coil array 200 are arranged so that a single cut surface can cut out parts of multiple coil portions 10.

### (m) Formation of Outer Cover

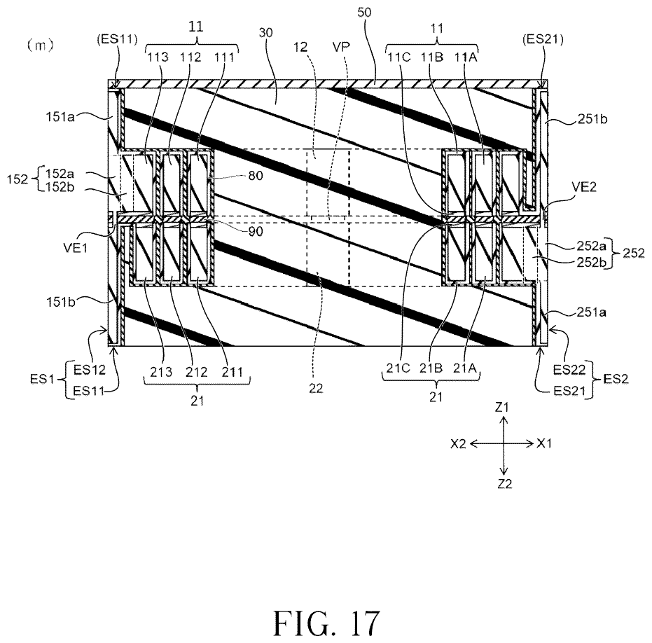

Next, an outer cover 50 is applied to part of the exposed portions of the main body portion 30, specifically the upper surface (the surface on Z1 side in Z1-Z2 direction) of the main body portion 30 in FIG. 17, to protect the main body portion 30. Although the main body portion 30 may remain as is, when external force is applied due to collision with other members, the insulating coating on the surface of the magnetic powder constituting the main body portion 30 may be scraped off, reducing the surface resistance of the main body portion 30. A decrease in surface insulation may lead to reduced reliability of the coil component 100. Therefore, it is preferable to provide the outer cover 50 made of an insulating material. In particular, in the manufacturing method according to this embodiment, since the first exposed part ES11 and the third exposed part ES21 are located on the upper surface (the surface on Z1 side in Z1-Z2 direction), which is opposite to the mounting surface side (Z2 side in Z1-Z2 direction) of the coil chip 220, it is preferable to cover these first exposed part ES11 and third exposed part ES21 with the outer cover 50.

### (n) Formation of External Electrodes

The method for forming the outer cover 50 is not particularly limited. Known methods such as printing or coating may be adopted. The material constituting the outer cover 50 may be a known material such as epoxy resin, and from the perspective of improving impact resistance, a composite material in which an inorganic material such as glass fiber is dispersed in an organic material such as epoxy resin may be preferable. In addition to improving insulation reliability and impact resistance, the outer cover 50 may also be formed to improve appearance quality and to improve the positional accuracy of the external electrodes formed in the next step (for example, to prevent plating spread). Step (m) may be repeated multiple times, and in that case, the outer cover 60 may be formed by Step (m).

Finally, an external electrode formation step is performed to form external electrodes that contact at least part of the exposed conductor portions, which is exposed from the coil chip 220 serving as the first member and electrically connected to the first spiral conductor portion 11. The exposed conductor portions on which the external electrodes are formed are the first exposed region ES1 formed from the first exposed part ES11 and the second exposed part ES12, and the second exposed region ES2 formed from the third exposed part ES21 and the fourth exposed part ES22, which are not sealed with the material containing magnetic powder when forming the main body portion 30.

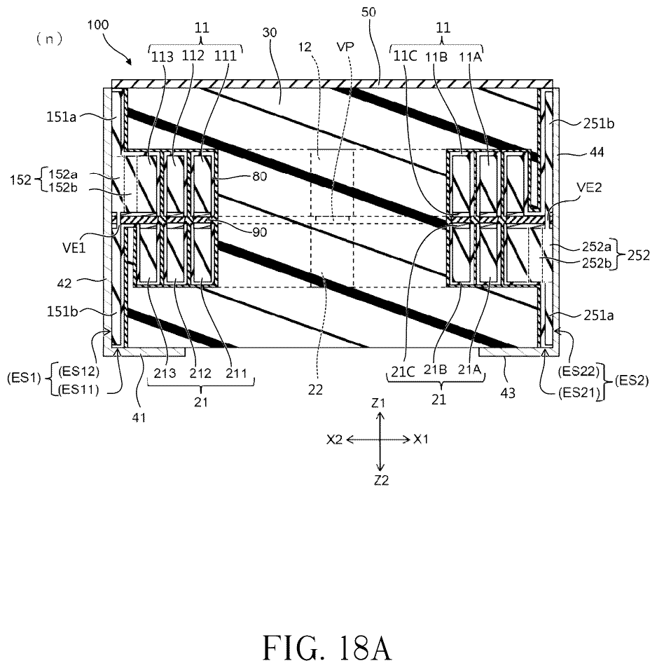

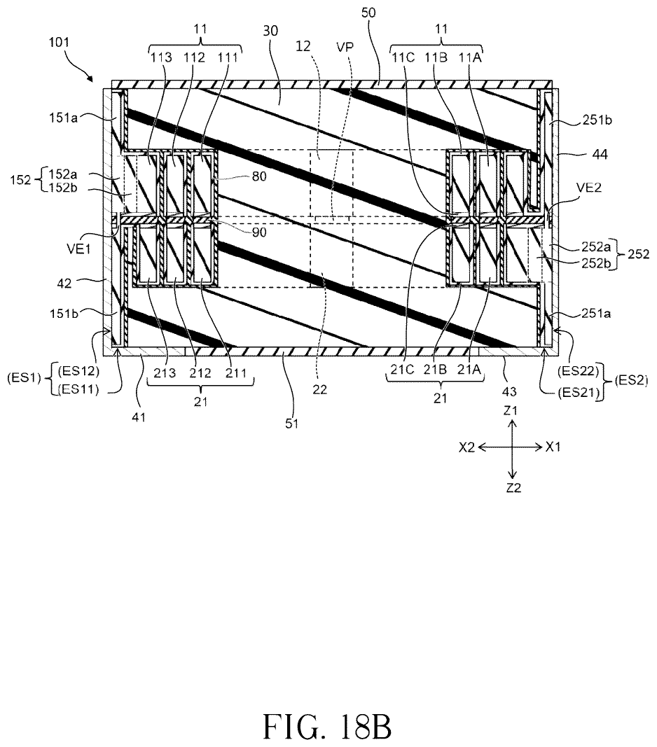

Specifically, as shown in FIG. 18A, the first external electrode 41 is formed to cover the first exposed part ES11 of the first exposed region ES1, the second external electrode 42 is formed to cover the second exposed part ES12 of the first exposed region ES1, the third external electrode 43 is formed to cover the third exposed part ES21 of the second exposed region ES2, and the fourth external electrode 44 is formed to cover the fourth exposed part ES22 of the second exposed region ES2. In the diagram shown in FIG. 18A, the first external electrode 41 and the second external electrode 42 are integrally formed, and the third external electrode 43 and the fourth external electrode 44 are integrally formed. Through the above steps, the coil component 100 is obtained.

The method for forming the first external electrode 41 to the fourth external electrode 44 is not particularly limited, and a plating process or a printing process can be exemplified. As described above, by forming the outer cover 50 before forming the external electrodes (first external electrode 41 and second external electrode 42), it is possible to prevent plated deposits from forming on unintended regions of the exposed surface of the main body portion 30, which could reduce the shape accuracy of the external electrodes or increase the risk of short-circuiting of the external electrodes (plating spread). From this viewpoint, as shown in FIG. 18B, it may be preferable that an outer cover 51 is also formed on the lower surface (Z2 side in Z1-Z2 direction), which becomes the mounting surface, in Step (n).

### (Modified Examples)

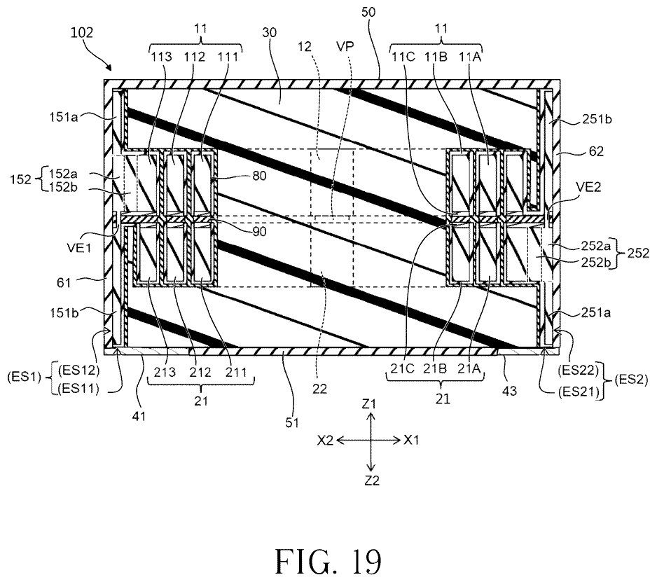

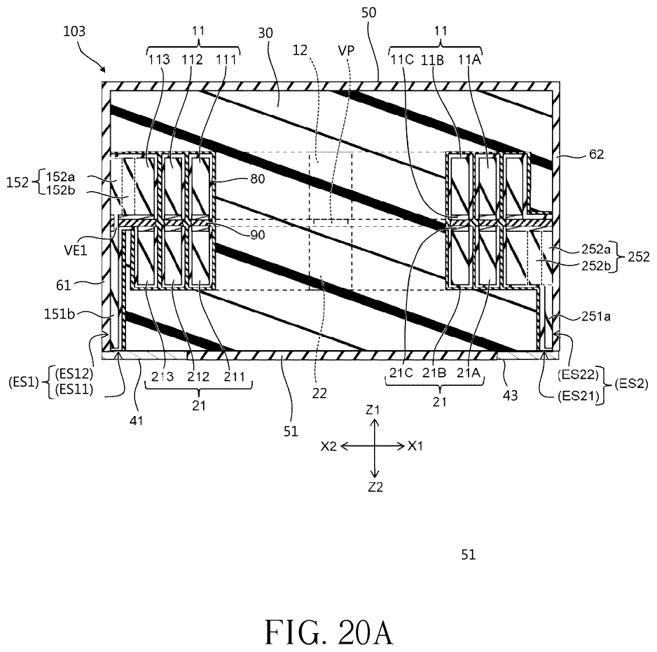

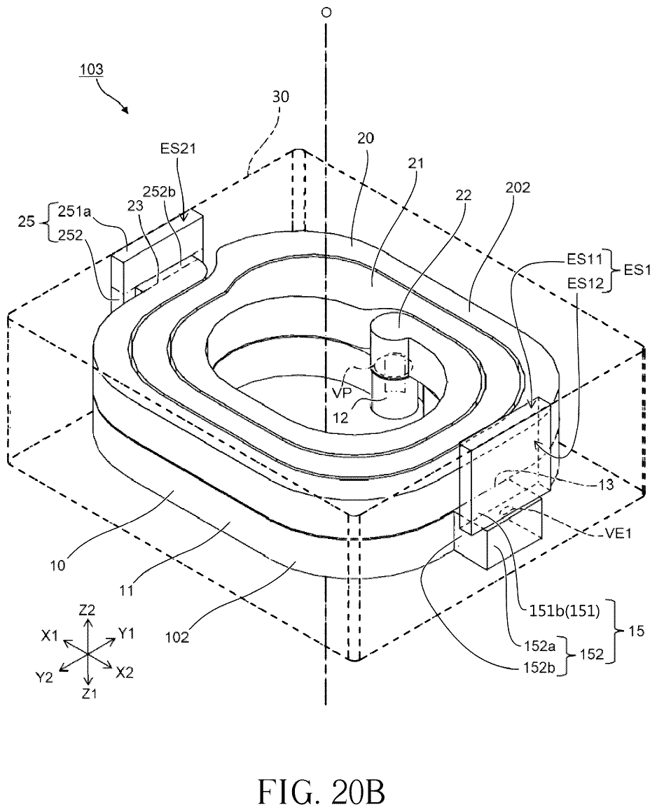

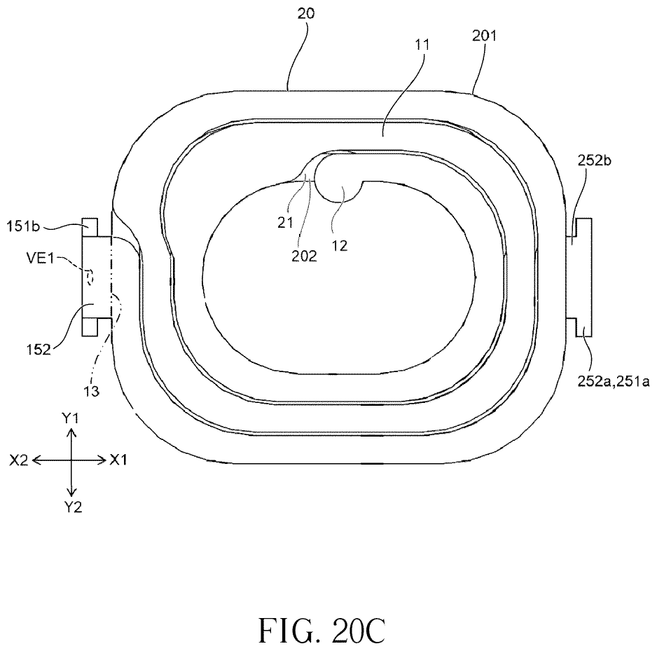

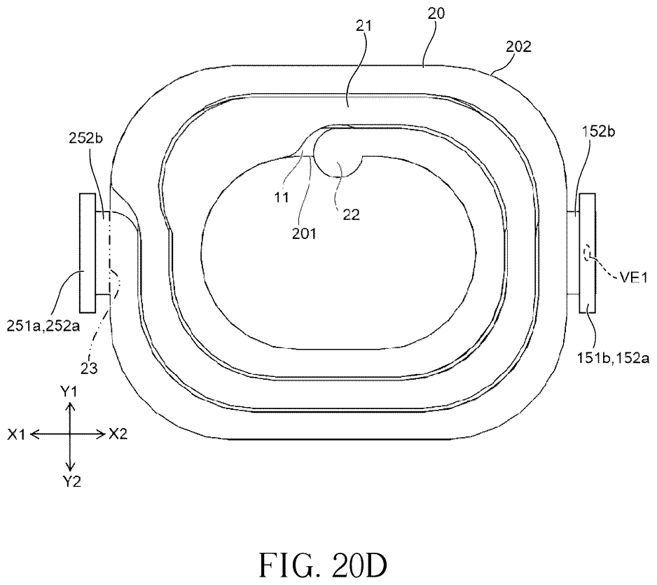

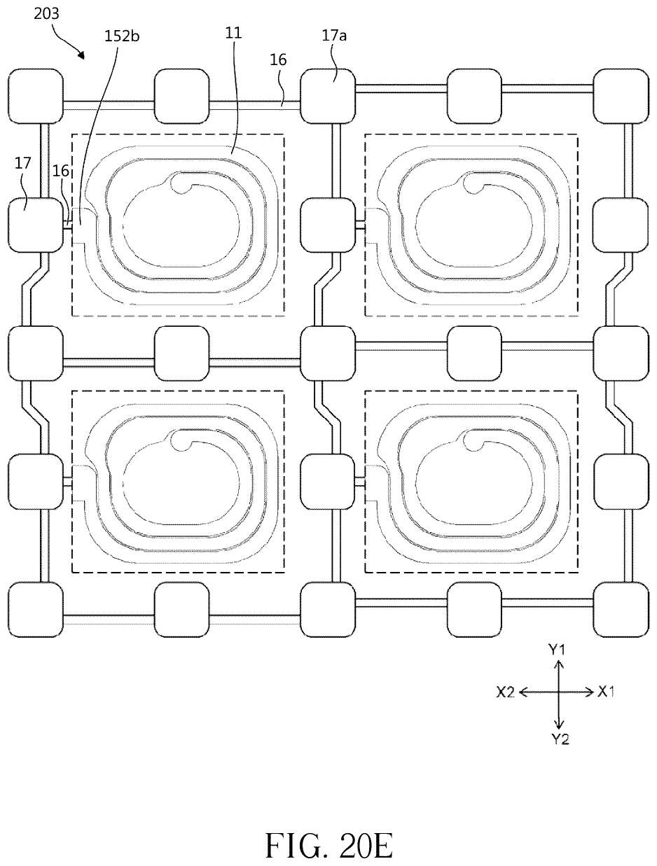

FIGS. 19 and 20A to 20E are explanatory diagrams of other examples (Examples 1 and 2) of the coil component according to an embodiment of the present invention. FIGS. 19 and 20A are XZ cross-sectional views, FIG. 20B is a perspective view with part cut away, FIG. 20C is a plan view of the coil conductor portion 20, FIG. 20D is a bottom view of the coil conductor portion 20, and FIG. 20E is a plan view of a coil array 203.

The coil component 102 shown in FIG. 19, compared with the coil component 101 shown in FIG. 18B, has an outer cover 61 provided instead of the second external electrode 42, which is provided to cover the second exposed part ES12, and an outer cover 62 provided instead of the fourth external electrode 44, which is provided to cover the fourth exposed part ES22. Since the outer cover 60 is also provided on the side surfaces of the main body portion 30 facing the Y1-Y2 direction, in the coil component 102, all side surfaces are covered by outer covers 60, 60, 61, and 62. By increasing insulation on surfaces other than the lower surface (Z2 side in Z1-Z2 direction), which is the mounting surface, it becomes easier to support high-density mounting. Therefore, even when there is a strong demand for miniaturization in the electronic/electric device in which the coil component 102 is mounted, it is easy to meet this demand.

The coil component 103 shown in FIGS. 20A to 20D, compared with the coil component 101 shown in FIG. 18B, does not have the first upper protrusion portion 151a and the second upper protrusion portion 251b. In other words, only the first lower protrusion portion 151b has the first exposed part ES11, and the first external electrode 41 is provided to cover this first exposed part ES11. Similarly, only the second lower protrusion portion 251a has the third exposed part ES21, and the third external electrode 43 is provided to cover this third exposed part ES21. By not having the first upper protrusion portion 151a and the second upper protrusion portion 251b, the amount of magnetic powder constituting the main body portion 30 of the coil component 103 can be increased compared with the amount of magnetic powder constituting the main body portion 30 of the coil component 101, and improvement in magnetic properties can be expected.

Since the coil component 103 does not have the first upper protrusion portion 151a, the cross section of the first base portion 152 with the current flow direction as the normal is equal to the shape of the cross section of the outer end part 13 with the current flow direction as the normal. Furthermore, since the coil component 103 does not have the second upper protrusion portion 251b, the second end via conductor portion VE2 is not provided. Therefore, when manufacturing the coil component 103 by the above manufacturing method, in FIG. 8, the pattern 15CPb of the conductive layer 55, which is part of the second partial pattern 15CP and has a wide width in the Y1-Y2 direction, and the second partial pattern 17CP are unnecessary, and the third partial pattern 16CP may be arranged at these positions.

When the pattern shape is changed in this way, when the first conductor portion is formed in Step (e), no portion with a large plated deposit height is formed near the first spiral conductor portion 11. This increases the amount of magnetic powder constituting the main body portion 30 as described above, but when a shape forming process is selected in Step (k) to supply a material containing magnetic powder so as to cover the first spiral conductor portion 11 with the Z1-Z2 direction as the pressing direction, it also means that the support portion 17 for supporting in the Z1-Z2 direction is not properly formed. In such a case, as shown in FIG. 20E, the shape of the support portion 17 may be changed so that the support portion 17 is located outside the cutting line DL when cutting out the coil chip 220 in Step (1). The rectangle shown by the broken line in FIG. 20E indicates the outer shape of the coil chip 220 obtained by cutting.

### (Electronic/Electric Device)

An electronic/electric device according to an embodiment of the present invention is an electronic/electric device in which the coil components 100, 101, 102, and 103 according to an embodiment of the present invention are mounted. The coil components 100, 101, 102, and 103 are connected to a substrate via terminal members (for example, first external electrode 41 and third external electrode 43) provided on exposed conductor portions (for example, the first exposed part ES11 and the third exposed part ES21) located at and exposed from the two ends of the coil conductor portion 20. Since the electronic/electric device according to an embodiment of the present invention includes the coil components 100, 101, 102, and 103 described above, miniaturization of the device is easy. In particular, the coil components 102 and 103 can easily support high-density mounting, so devices equipped with these components are especially easy to miniaturize. Furthermore, even when a large current flows or a high frequency is applied within the device, malfunctions caused by performance degradation or heat generation of the coil components 100, 101, 102, and 103 are unlikely to occur.

The embodiments and examples described above are provided to facilitate understanding of the present invention and are not intended to limit the present invention. Therefore, all design modifications and equivalents of the elements disclosed in the above embodiments are intended to be included within the technical scope of the present invention. For example, although the coil components 100, 101, 102, and 103 do not include either the portion based on the first connecting member 16 including the third plated portion PP3 or the portion based on the second connecting member 26 including the sixth plated portion PP6, they may include at least one of these portions. Specifically, when cutting out the coil chip 220 from the plate material 210, the cut surface may be set so that these portions are included.

1. A coil component, comprising:
a coil conductor portion, comprising a first spiral conductor portion having a spiral shape when viewed in a first direction, and a first connecting conductor portion having a first protrusion part protruding further than the first spiral conductor portion on at least one side in the first direction and contacting one of a pair of end parts of the first spiral conductor portion; and
a main body portion, covering at least the first spiral conductor portion with a pair of intersecting surfaces arranged alongside in the first direction, and including a magnetic powder,
wherein the first connecting conductor portion has a first exposed region exposed from the main body portion, and the first protrusion part has a portion formed by a continuous body extending in the first direction.

2. The coil component according to claim 1, wherein the first exposed region has a first exposed part exposed from the intersecting surfaces.

3. The coil component according to claim 1, wherein the main body portion has an outer surface extending in the first direction between the pair of intersecting surfaces.

4. The coil component according to claim 3, wherein the first exposed region is exposed from a portion of the main body portion other than the outer surface.

5. The coil component according to claim 2, further comprising a first external electrode provided outside the main body portion and in contact with the first exposed part.

6. The coil component according to claim 1, wherein the main body portion has an outer surface extending in the first direction between the pair of intersecting surfaces, and the first exposed region has a second exposed part exposed from the outer surface.

7. The coil component according to claim 6, wherein the second exposed part is formed from a cut surface.

8. The coil component according to claim 6, further comprising a second external electrode provided outside the main body portion and in contact with the second exposed part.

9. The coil component according to claim 8, where the first exposed region has a first exposed part exposed from the intersecting surfaces, and the second external electrode extends to also contact the first exposed part.

10. The coil component according to claim 1, wherein the first protrusion part protrudes further than the first spiral conductor portion on both sides in the first direction.

11. The coil component according to claim 1, wherein the first protrusion part protrudes further than the first spiral conductor portion on one side in the first direction.

12. The coil component according to claim 1, wherein the first connecting conductor portion comprises:
a first base portion extending from an outer end of the pair of end parts of the first spiral conductor in a direction intersecting the first direction, and facing the first protrusion part at one end in the first direction; and
a first end via conductor portion electrically connecting the first protrusion part and the first base portion.

13. The coil component according to claim 12, wherein in the first protrusion part, a position in the first direction where the cross-sectional area perpendicular to the first direction is minimal is closer to the first end via conductor portion than a position in the first direction where the cross-sectional area perpendicular to the first direction is maximal.

14. The coil component according to claim 13, wherein the first exposed region has a first exposed part exposed from the intersecting surfaces, and a cross section of the first protrusion part perpendicular to the first direction has a maximal area at the first exposed part.

15. The coil component according to claim 1, further comprising a portion formed by a laminated structure, which includes a first conductor portion and a second conductor portion provided on a surface of the first conductor portion.

16. The coil component according to claim 1, wherein the coil conductor portion comprises:
a second spiral conductor portion arranged alongside in the first direction with the first spiral conductor portion and having a spiral shape when viewed in the first direction;
a second connecting conductor portion comprising a second protrusion part, which protrudes further on at least one side in the first direction than the second spiral conductor portion, and contacting one of a pair of end parts of the second spiral conductor portion; and
a via conductor portion in contact with one end of the first spiral conductor portion and one end of the second spiral conductor portion to electrically connect the first spiral conductor portion and the second spiral conductor portion in the first direction,
wherein the second connecting conductor portion has a second exposed region exposed from the main body portion, and the second protrusion part has a portion formed from a continuous body extending in the first direction.

17. A method for manufacturing a coil component, the coil component comprising a coil member, the coil member comprising a coil conductor portion, the coil conductor portion comprising a first spiral conductor portion comprising spiral-shaped turns when viewed in a first direction,
wherein the coil component is manufactured by steps comprising:
a pattern forming step, comprising forming a first conductor pattern, which is a pattern of a conductive layer, on a first substrate surface, which is a surface of an insulating sheet substrate; and
a plating step, comprising applying an electric current to the conductive layer to perform an electroplating process, forming a first plated deposit on the first conductor pattern, and forming a first conductor portion containing at least partially the first spiral conductor portion,
wherein the first conductor pattern comprises:
a first portion pattern having a spiral shape corresponding to the first spiral conductor portion; and
a second portion pattern having a circle equivalent diameter of at least 1.5 times a minimal width of the spiral-shaped turns of the first portion pattern,
wherein the first conductor portion comprises:
a first plated portion formed in the first portion pattern and forms at least partially the first spiral conductor portion; and
a second plated portion formed in the second portion pattern, and
wherein a maximal length of the second plated portion in the first direction is 1.2 times or more a maximal length of the first plated portion in the first direction.

18. The method for manufacturing the coil component according to claim 17, wherein the first portion pattern and the second portion pattern are continuous on the first substrate surface.

19. The method for manufacturing the coil component according to claim 17, wherein the first conductor pattern comprises a plurality of the first portion patterns and the second portion patterns, and the first conductor pattern comprises a third portion pattern that satisfies at least one of the following:
two of the first portion patterns are connected on the first substrate surface;
two of the second portion patterns are connected on the first substrate surface; and
one of the first portion patterns and one of the second portion patterns are connected on the first substrate surface.

20. The method for manufacturing the coil component according to claim 17, wherein in the pattern forming step, the first conductor pattern is formed by arranging an insulating negative pattern having an inverted shape of the first conductor pattern on the conductive layer.

21. The method for manufacturing the coil component according to claim 17, wherein the first plated deposit is made of a material containing Cu.

22. The method for manufacturing the coil component according to claim 17, further comprising at least after the first plating step, a sheet removal step of removing the sheet substrate in a region surrounded by an inner edge of the first spiral conductor portion when viewed in the first direction.

23. An electronic/electric device, being installed therein the coil component according to claim 1, wherein the coil component is connected to a substrate with terminal members respectively disposed on exposed conductor portions, which are located at the two end parts of the coil conductor portion and exposed outwards.
